(19) United States
(12) Patent Application Publication
(10) Pub. No.: US 2015/0324798 A1
(43) Pub. Date: Nov. 12, 2015

(54) POWER SUPPLY METHOD, BILLING PROCESSING METHOD, POWER SUPPLY SYSTEM, POWER SUPPLY CONTROLLER, POWER SUPPLY APPARATUS, POWER-SUPPLY CONTROL METHOD, MANAGEMENT SERVER, ELECTRIC VEHICLE, AND BILLING SERVE

(71) Applicant: Panasonic Intellectual Property Management Co., Ltd., Osaka (JP)

(72) Inventors: TOSHIFUMI KAI, Osaka (JP); YUSUKE OMOTE, Osaka (JP); SIHAN DONG, Osaka (JP); YUICHI AOKI, Osaka (JP)

(21) Appl. No.: 14/702,052

(22) Filed: May 1, 2015

(30) Foreign Application Priority Data
May 9, 2014 (JP) 2014-097535

(51) Int. Cl. G06Q 20/40; B60L 11/18; G06Q 20/14; G06Q 20/32; H04W 12/06; G06Q 50/06

(52) U.S. Cl. CPC G06Q 20/40; H04W 12/06; G06Q 50/06; G06Q 20/145; G06Q 20/3224; B60L 11/1848; B60L 11/1846; B60L 11/182

(57) ABSTRACT

A power supply system includes an authentication server. Before receiving power supplied from a power supply coil of a power supply apparatus, an electric vehicle is authenticated by the authentication server. For receiving power supplied from the power supply coil, the electric vehicle gives a power-supply request to request a power-supply controller, which controls the power supply apparatus, to issue a temporary ticket for receiving power supply. The electric vehicle transmits the temporary ticket to the power supply apparatus, and upon determining that the temporary ticket is legitimate, the power supply apparatus executes power supply.

### BACKGROUND

1. Technical Field

The present disclosure relates to a power supply system for supplying power to an electric vehicle, a power supply method, a billing processing method, a power supply controller, a power supply apparatus, a power-supply control method, a management server, an electric vehicle, and a billing server.

2. Description of the Related Art

In recent years, electric vehicles are increasingly used. The distance that can be traveled by an electric vehicle is defined according to power accumulated in a battery installed therein. Since the distance that can be traveled decreases as the remaining charge in the battery decreases, charging the electric vehicle is essential in order to allow the electric vehicle to continue to travel.

Heretofore, studies have been carried out on development of a charging system for batteries in electric vehicles. For example, Japanese Unexamined Patent Application Publication No. 2012-200043 (Patent Document 1) discloses a system for transferring power between electric vehicles, that is, a system for charging an electric vehicle by using another electric vehicle. International Publication No 2013/073625 (Patent Document 2) discloses an electronic-vehicle (EV) charging system, like a gas station for gasoline-powered vehicles, for supplying power for electric vehicles. Japanese Unexamined Patent Application Publication No. 2013-51744 (Patent Document 3) discloses charging a battery after battery authentication is performed in a wireless power supply system that supplies power to a traveling electric vehicle by using a power supply apparatus installed on a roadway.

In the wireless power supply system disclosed in Patent Document 3, it is not possible to start power supply in a short time while performing highly reliable authentication.

### SUMMARY

One non-limiting and exemplary embodiment provides a power supply system in which the reliability of authentication is high. In one general aspect, the techniques disclosed here feature a power supply method for a power supply system for supplying power to an electric vehicle that travels on a roadway by using a power supply apparatus installed for the roadway. The power supply method includes: causing the power supply system to execute authentication as to whether or not the electric vehicle has legitimacy to receive power supply, before the electric vehicle arrives in a section where the power supply apparatus is installed for the roadway; and delivering a first temporary ticket to the electric vehicle and delivering a second temporary ticket to the power supply apparatus when the authentication of the electric vehicle succeeds, the first and second temporary tickets serving as a temporary ticket for the electric vehicle to receive power supplied from the power supply apparatus. In the power supply method, the power supply apparatus receives the delivered second temporary ticket, receives the first temporary ticket when the first temporary ticket is transmitted from the electric vehicle, determines whether or not the received second temporary ticket and the received first temporary ticket match each other, and supplies power to the electric vehicle, upon determining that the received second temporary ticket and the received first temporary ticket match each other.

The power supply system according to this aspect makes it possible to start power supply in a short time while performing highly reliable authentication.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a system configuration diagram of a power supply system according to a first embodiment;

FIG. 2 is a functional block diagram of a power-supply controller according to the first embodiment;

FIG. 3 is a functional block diagram of a power supply apparatus according to the first embodiment;

FIG. 4 is a functional block diagram of an authentication server according to the first embodiment;

FIG. 5 is a functional block diagram of an electric vehicle according to the first embodiment;

FIG. 6 is a functional block diagram of a billing server according to the first embodiment;

FIG. 7 is a conceptual table of data in an authentication database (DB) held by the authentication server according to the first embodiment;

FIG. 8 is a conceptual table of data in an authentication DB held by the authentication server according to the first embodiment;

FIG. 9 is a conceptual diagram of data in a billing information DB held by the billing server according to the first embodiment;

FIG. 10 is a sequence diagram illustrating a flow until the power supply system according to the first embodiment supplies power;

FIG. 11 is a system of a power supply system according to a second embodiment;

FIG. 12 is a functional block diagram of a power supply apparatus according to the second embodiment;

FIG. 13 is a sequence diagram illustrating a flow until the power supply system according to the second embodiment supplies power;

FIG. 14 is a sequence diagram illustrating operations in the power supply system according to the third embodiment;

FIG. 15 is a sequence diagram illustrating operations in the power supply system according to the third embodiment;

FIG. 16 is a sequence diagram illustrating operations in the power supply system according to the third embodiment;

FIG. 17 is a sequence diagram illustrating operations in the power supply system according to the third embodiment;

FIG. 18 is a flowchart illustrating operations in a billing server according to the third embodiment;

FIG. 19 illustrates one example of a usage statement for power supply;

FIG. 20 illustrates one example of an external appearance of a power supply system according to a fourth embodiment;

FIG. 21 is a functional block diagram of an electric vehicle according to the fourth embodiment;

FIG. 22 is a flowchart illustrating operations of the electric vehicle according to the fourth embodiment;

FIG. 23 illustrates one example of an external appearance of the power supply system according to the fourth embodiment;

FIG. 24 is a functional block diagram of a navigator according to the fourth embodiment;

FIG. 25 is a flowchart illustrating operations of the navigator according to the fourth embodiment;

FIG. 26 is a functional block diagram of the electric vehicle according to the fourth embodiment;

FIG. 27 is a flowchart illustrating operations of the electric vehicle according to the fourth embodiment;

FIG. 28 illustrates an example of display of the guidance information;

FIG. 29 illustrates an example of display of the guidance information;

FIG. 30 is a system diagram of a power supply system according to a fifth embodiment;

FIG. 31 is a functional block diagram of an electric vehicle according to the fifth embodiment;

FIG. 32 is a functional block diagram of a navigation server;

FIG. 33 is a conceptual diagram of data in a navigation DB held by the navigation server;

FIG. 34 is a sequence diagram illustrating operations of the power supply system according to the fifth embodiment; and

FIG. 35 illustrates an example of an interface screen for navigation.

### DETAILED DESCRIPTION

### Findings Obtained by Present Inventors

The present inventors made extensive and earnest study to realize a wireless power supply system that supplies power to traveling vehicles. As a result, the present inventors have made the following findings.

In the wireless power supply system, a service of supplying power is provided. The owner of an electric vehicle that receives power supply is billed. Thus, it is necessary to perform highly reliable authentication in order to prevent power supply due to electricity theft or impersonation from being performed in a section where the power supply apparatus is installed. Considering that power is supplied to a traveling vehicle, it is necessary to perform authentication in a short time.

When a more advanced, more complicated algorithm is used as an authentication algorithm in order to perform highly reliable authentication, it takes a long period of time for the authentication. Conversely, when the authentication is simplified in order to perform the authentication in a short time, the reliability of the authentication is lost.

As a result of extensive and earnest studies, the present inventors have found that dividing processing into a step of determining whether or not an electric vehicle has legitimacy to receive power supply and a step of starting the power supply by using predetermined identification information (a temporary ticket issued when the electric vehicle has the legitimacy to receive power supply) makes it possible to start the power supply in a short time while performing highly reliable authentication.

On the basis of the above-described findings, the present inventors have conceived the aspects described below.

A power supply method according to a first aspect of the present disclosure is directed to a power supply method for a power supply system for supplying power to an electric vehicle that travels on a roadway by using a power supply apparatus installed for the roadway. The power supply method includes: causing the power supply system to execute authentication as to whether or not the electric vehicle has legitimacy to receive power supply, before the electric vehicle arrives in a section where the power supply apparatus is installed for the roadway; and delivering a first temporary ticket to the electric vehicle and delivering a second temporary ticket to the power supply apparatus when the power supply system authenticates that the electric vehicle has the legitimacy, the power supply apparatus supplying power to the electric vehicle upon determining that the first and second virtual tickets match each other. In the power supply method, the power supply apparatus receives the delivered second temporary ticket, receives the first temporary ticket when the first temporary ticket is transmitted from the electric vehicle, determines whether or not the received second temporary ticket and the received first temporary ticket match each other, and supplies power to the electric vehicle, upon determining that the received second temporary ticket and the received first temporary ticket match each other. According to the first aspect of the present disclosure, authentication as to whether or not the electric vehicle has the legitimacy to receive power supply is executed by the power supply system in advance, and then, in actual power supply, authentication is performed by verifying a match of the temporary ticket, and the power supply is triggered by transmission/reception of the temporary ticket. Thus, even when an advanced, complicated algorithm is used to perform authentication as to whether or not the electric vehicle has the legitimacy to receive power supply, the electric vehicle can receive power supply in a short time in a section where the power supply apparatus is installed. Thus, according to the first aspect, it is possible to start power supply in a short time while performing highly reliable authentication.

Compared with the wireless power supply system disclosed in Patent Document 3, the first aspect of the present disclosure is superior in the following points.

Authentication in Patent Document 3 is described in the following manner. When a vehicle passes through a charging area, radio-wave communication is performed between a coil provided in the vehicle and a coil provided in the charging area. A control unit provided in the charging area performs battery authentication on the basis of (identification) ID information of a battery provided in a vehicle, the ID information being obtained by radio-wave communication. Thus, in Patent Document 3, before an electric vehicle receives power, the control unit provided in the power supply area determines whether or not the electric vehicle has legitimacy to receive power supply.

In Patent Document 3, if a more advanced, more complicated algorithm is used as the authentication algorithm in order to perform highly reliable authentication, it takes a long period of time for the authentication. In contrast, if the authentication is simplified so that it is performed in a short time, the reliability of the authentication is lost. Thus, in the wireless power supply system disclosed in Patent Document 3, it is not possible to start power supply in a short time while performing highly reliable authentication.

In contrast, according to the power supply method in the present disclosure, authentication as to whether or not the electric vehicle has the legitimacy to receive power supply is executed by the power supply system in advance, and then, in actual power supply, authentication is performed by verifying a match of the temporary ticket, and the power supply is triggered by transmission/reception of the temporary ticket. Thus, even when an advanced, complicated algorithm is used to perform authentication as to whether or not the electric vehicle has the legitimacy to receive power supply, the electric vehicle can receive power supply in a short time in a section where the power supply apparatus is installed. As described above, the power supply method according to the first aspect makes it possible to start power supply in a short time, while performing highly reliable authentication.

In a second aspect, for example, in the power supply method according to the first aspect, when the electric vehicle is authenticated as having the legitimacy, the first temporary ticket and the second temporary ticket are issued, the first temporary ticket is delivered to the electric vehicle, and the second temporary ticket is delivered to the power supply apparatus.

In a third aspect, for example, in the power supply apparatus in the power supply method according to the first aspect, a request signal for requesting the first temporary ticket may be transmitted to the electric vehicle, and the first temporary ticket may be received from the electric vehicle in response to the request signal.

In a fourth aspect, for example, in the power supply system in the power supply method according to the first aspect, identification information and authentication information of the electric vehicle may be received from the electric vehicle, before the electric vehicle arrives in the section, an authentication server included in the power supply system may be requested to authenticate the identification information and the authentication information, and the first temporary ticket and the second temporary ticket may be issued based on an authentication result reported from the authentication server.

In a fifth aspect, in the power supply method according to the first aspect, the power supply apparatus may further receive, from the electric vehicle, travel-speed information indicating a speed at which the electric vehicle travels and travel-route information indicating a route along which the electric vehicle travels; the power supply system may further specify the power supply apparatus that executes power supply to the electric vehicle, based on the travel-speed information and the travel-route information; and the specified power supply apparatus may supply power to the electric vehicle.

In a sixth aspect, for example, the power supply system in the power supply method according to the fifth aspect may further determine a timing at which the electric vehicle passes by the power supply apparatus, based on the travel-speed information, and may report the determined timing to the power supply apparatus; and the power supply apparatus may execute starting and ending of the power supply, based on the reported timing.

In a seventh aspect, for example, the power supply system in the power supply method according to the first aspect may further include a billing server that executes billing processing in association with a user ID indicating a user of the electric vehicle, when the power supply apparatus executes the power supply to the electric vehicle.

In an eighth aspect, for example, the billing server in the power supply method according to the seventh aspect may execute the billing processing in accordance with the amount of power that the power supply apparatus supplies to the electric vehicle.

In a ninth aspect, for example, the billing server in the power supply method according to the seventh or eighth aspect may execute the billing processing in accordance with the amount of power received by the electric vehicle.

In a tenth aspect, for example, the authentication server included in the power supply system according to one of the first to ninth aspects may execute the authentication as to whether or not the electric vehicle has the legitimacy to receive power supply.

In an 11th aspect, for example, in the authentication in the power supply method according to one of the first to tenth aspects, a user ID that is identification information indicating an electric vehicle or an owner thereof is used, and when it is determined that the user ID matches pre-stored information, it is determined that the electric vehicle has the legitimacy to receive power supply.

A power supply system according to a 12th aspect of the present disclosure is directed to a power supply system for supplying power to an electric vehicle that travels on a roadway by using a power supply apparatus installed for the roadway. The power supply system includes: a power-supply controller that causes the power supply system to execute authentication as to whether or not the electric vehicle has legitimacy to receive power supply, before the electric vehicle arrives in a section where the power supply apparatus is installed for the roadway, and delivers a first temporary ticket to the electric vehicle and delivers a second temporary ticket to the power supply apparatus when the authentication of the electric vehicle succeeds, the first and second temporary tickets serving as a temporary ticket for the electric vehicle to receive power supplied from the power supply apparatus. The power supply apparatus receives the delivered second temporary ticket, receives the first temporary ticket when the first temporary ticket is transmitted from the electric vehicle, determines whether or not the received second temporary ticket and the received first temporary ticket match each other, and supplies power to the electric vehicle, upon determining that the received second temporary ticket and the received first temporary ticket match each other.

In the 13th aspect, for example, the power supply system according to the 12th aspect may further include an authentication server that executes the authentication as to whether or not the electric vehicle has the legitimacy to receive power supply.

A power supply apparatus according to a 14th aspect of the present disclosure is used in the power supply system according to the 12th aspect.

An electric vehicle according to a 15th aspect of the present disclosure is used in the power supply system according to the 12th aspect.

A billing server according to a 16th aspect of the present disclosure is used in the power supply system according to the 12th aspect. The billing server may include a selector that receives amount-of-supplied-power information indicating an amount of power supplied from the power supply apparatus to the electric vehicle and performs billing processing for the amount of supplied power in association with a user ID indicating a user of the electric vehicle.

A billing server according to a 17th aspect of the present disclosure is used in the power supply system according to the 12th aspect. The billing server may include: a selector that selects one of a first billing method based on an amount of power that the power supply apparatus supplies to the electric vehicle, a second billing method based on an amount of power received by the electric vehicle, and a third billing method based on both the amount of power supplied and the amount of power received; and a billing processor that executes the billing processing in accordance with the billing method selected by the selector.

A billing processing method according to an 18th aspect of the present disclosure is directed to a billing processing method executed by a billing server used in the power supply system according to the 12th aspect. The billing processing method may include: selecting one of a first billing method based on an amount of power that the power supply apparatus supplies to the electric vehicle, a second billing method based on an amount of power received by the electric vehicle, and a third billing method based on both the amount of power supplied and the amount of power received; and executing the billing processing in accordance with the selected billing method.

A power-supply controller according to a 19th aspect of the present disclosure is directed to a power-supply controller used in a power supply system that supplies power to an electric vehicle that travels on a roadway by using a power supply apparatus installed for the roadway. The power-supply controller includes: causing the power supply system to execute authentication as to whether or not the electric vehicle has legitimacy to receive power supply, before the electric vehicle arrives in a section where the power supply apparatus is installed for the roadway; and delivering a first temporary ticket to the electric vehicle and delivering a second temporary ticket to the power supply apparatus when the authentication of the electric vehicle succeeds, the first and second temporary tickets serving as a temporary ticket for the electric vehicle to receive power supplied from the power supply apparatus. The power supply apparatus receives the delivered second temporary ticket, receives the first temporary ticket when the first temporary ticket is transmitted from the electric vehicle, determines whether or not the received second temporary ticket and the received first temporary ticket match each other, and supplies power to the electric vehicle, upon determining that the received second temporary ticket and the received first temporary ticket match each other.

A power supply apparatus according to a 20th aspect of the present disclosure is directed to a power supply apparatus that supplies power to an electric vehicle that travels on a roadway. The power supply apparatus includes: a first receiver that receives a first temporary ticket delivered from a server: a second receiver that receives a second temporary ticket transmitted from the electric vehicle; a determiner that determines whether or not the first temporary ticket received by the first receiver and the second temporary ticket received by the second receiver match each other; and a power supplier that supplies power to the electric vehicle, when the determiner determines that the first temporary ticket and the second temporary ticket match each other.

A management server according to a 21st aspect of the present disclosure is directed to a management server that controls a power supply apparatus installed for a roadway and manages power supply performed on an electric vehicle that travels on the roadway. The management server includes: a communicator that is connected to an authentication server that performs authentication as to whether or not the electric vehicle has legitimacy to receive power supply, before the electric vehicle arrives in a section where the power supply apparatus is installed for the roadway; a first deliverer that delivers a first temporary ticket to the electric vehicle as a temporary ticket for the electric vehicle to receive power supplied from the power supply apparatus, upon receiving, from the authentication server via the communicator, an authentication result indicating that the electric vehicle has the legitimacy; and a second deliverer that delivers a second temporary ticket to the power supply apparatus.

A power-supply control method according to a 22nd aspect of the present disclosure is directed to a power-supply control method that controls a power supply apparatus installed for a roadway. The method includes: performing, by using an authentication server, authentication as to whether or not an electric vehicle that travels on a roadway has legitimacy to receive power supply, before the electric vehicle arrives in a section where the power supply apparatus is installed for the roadway; delivering a first temporary ticket to the electric vehicle as a temporary ticket for the electric vehicle to receive power supplied from the power supply apparatus, when an authentication result of the authentication server indicates that the electric vehicle has the legitimacy; and delivering a second temporary ticket to the power supply apparatus.

An electric vehicle according to a 23rd aspect of the present disclosure is directed to an electric vehicle that is charged while traveling by using a power supply apparatus installed for a roadway. The electric vehicle includes: a battery unit that has one or more batteries; a power receiver that receives power from the power supply apparatus; a communicator connected to an authentication server that performs authentication as to whether or not the electric vehicle has legitimacy to receive power supply and a management server that delivers a temporary ticket for the electric vehicle to receive power supplied from the power supply apparatus; and a power controller that performs power control on the electric vehicle. The power controller transmits an authentication request for the electric vehicle by using the communicator to connect to the authentication server, before the electric vehicle arrives in a section where the power supply apparatus is installed for the roadway; transmits a delivery request for the temporary ticket to the management server, in response to successful authentication of the electric vehicle, the authentication being performed by the authentication server, wherein in response to the delivery request, the management server delivers a first temporary ticket to be delivered to the electric vehicle and a second temporary ticket to be delivered to the power supply apparatus; receives the first temporary ticket from the management server; transmits the received first temporary ticket to the power supply apparatus; and charges the battery unit by using power received from the power supply apparatus via the power receiver, when the power supply apparatus determines that the first temporary ticket and the second temporary ticket that the power supply apparatus receives from the management server match each other.

In a 24th aspect, in the power supply method according to the first aspect, after the electric vehicle passes through the section where the power supply apparatus is installed for the roadway, the power supply apparatus may further delete the second temporary ticket.

In a 25th aspect, in the power supply system according to the 12th aspect, after the electric vehicle passes through the section where the power supply apparatus is installed for the roadway, the power supply apparatus may further delete the second temporary ticket.

In a 26th aspect, in the power-supply controller according to the first aspect, after the electric vehicle passes through the section where the power supply apparatus is installed for the roadway, the power supply apparatus may further delete the second temporary ticket.

In any of the 24th to 26th aspects, if a third party intercepts the temporary ticket, the intercepted temporary ticket is deleted. Thus, electricity theft by the third party or power supply due to impersonation can be prevented in the section where the power supply apparatus is installed.

The description below will be given of details of a power supply system according to the present disclosure.

### First Embodiment

An example of a power supply system according to a first embodiment will be described below with reference to the accompanying drawings.

### <Configuration>

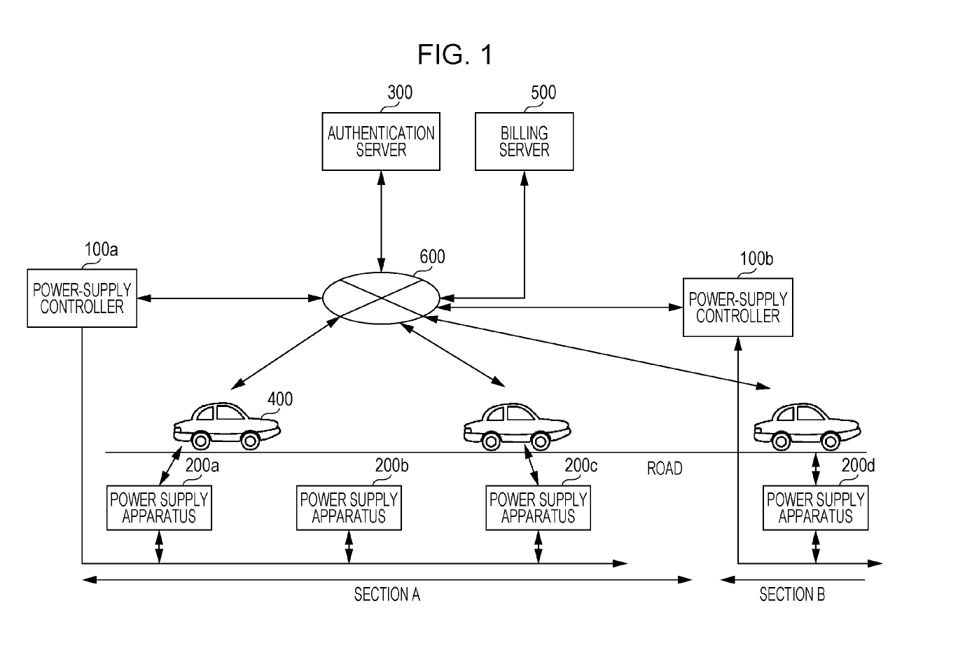

FIG. 1 is a system configuration diagram of a power supply system according to the first embodiment.

The power supply system includes power-supply controllers 100a and 100b and power supply apparatuses 200a, 200b, 200c, and 200d, an authentication server 300, and a billing server 500. An electric vehicle 400 uses this power supply system to receive power while traveling.

In the power supply system illustrated in FIG. 1, the electric vehicle 400 communicates with the authentication server 300 to transmit an authentication request. Upon receiving the authentication request, the authentication server 300 authenticates the electric vehicle 400. The authentication server 300 issues a temporary ticket for the electric vehicle 400 to receive power supplied from the power-supply controllers 100a and 100b. The authentication server 300 transmits the temporary ticket to the power supply apparatuses 200a, 200b, 200c, and 200d. As a result, the electric vehicle 400 can receive power from each power supply apparatus, as appropriate. A fee for the received power is billed by the billing server 500.

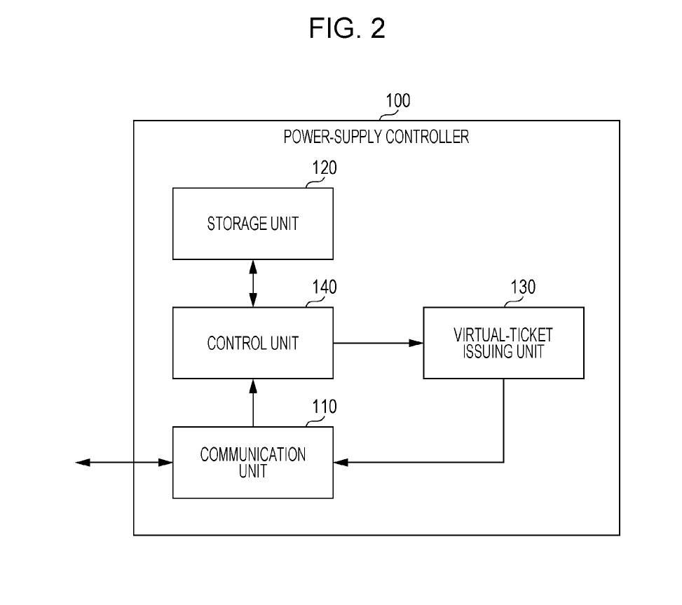

FIG. 2 is a functional block diagram of a power-supply controller 100. Although the power-supply controllers 100a and 100b are independently illustrated in FIG. 1, they have substantially the same configuration and thus are collectively referred to as a “power-supply controller 100” hereinafter.

As illustrated in FIG. 2, the power-supply controller 100 includes a communication unit 110, a storage unit 120, a temporary ticket issuing unit 130, and a control unit 140.

The communication unit 110 has a function for executing communication with the authentication server 300, the electric vehicle 400, and the billing server 500 through a network 600. The communication unit 110 communicates with each power supply apparatus through a dedicated channel for the power supply system.

The storage unit 120 stores a program and data needed for operation of the power-supply controller 100.

In accordance with an instruction from the control unit 140, the temporary ticket issuing unit 130 generates a temporary ticket. The temporary ticket issuing unit 130 requests the communication unit 110 so as to transmit the generated temporary ticket to each power supply apparatus and the electric vehicle 400.

The control unit 140 controls the individual units in the power-supply controller 100. Upon receiving a ticket issuance request (a ticket delivery request) from the electric vehicle 400 via the communication unit 110, the control unit 140 generates an authentication request including identification information of the electric vehicle 400, the identification information being included in the ticket issuance request, and digital signature information. The control unit 140 transmits the generated authentication request to the authentication server 300 via the communication unit 110. Upon receiving a response indicating that the authentication is successful from the authentication server 300, the control unit 140 instructs the temporary ticket issuing unit 130 to issue a temporary ticket to the authenticated electric vehicle 400.

In order to certify the legitimacy of the power-supply controller 100, the control unit 140 requests the authentication server 300 to authenticate the power-supply controller 100.

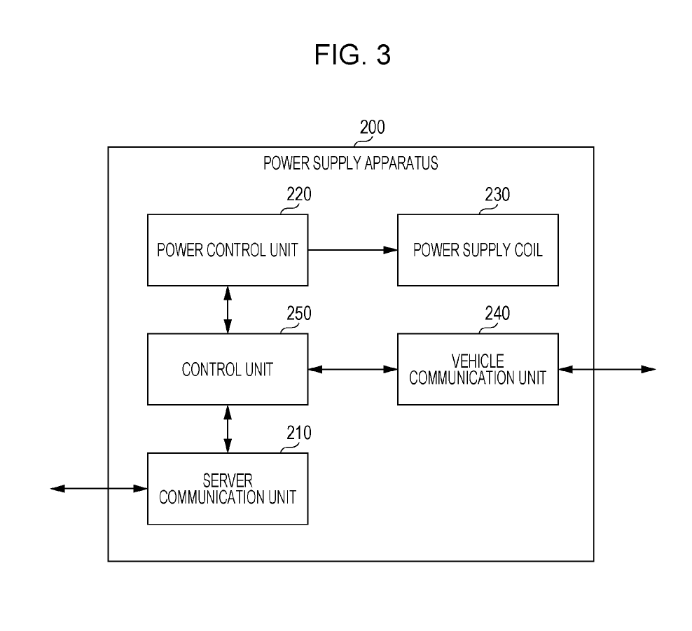

FIG. 3 is a functional block diagram of a power supply apparatus 200. Although the power supply apparatuses 200a, 200b, 200c, and 200d are independently illustrated in FIG. 1, they all have substantially the same configuration and are thus collectively referred to as “power supply apparatus 200” hereinafter.

As illustrated in FIG. 3, the power supply apparatus 200 includes a server communication unit 210, a power control unit 220, a power supply coil 230, a vehicle communication unit 240, and a control unit 250.

The server communication unit 210 communicates with the power-supply controller 100 connected thereto.

The power control unit 220 has a function for supplying power to the power supply coil 230 in accordance with an instruction from the control unit 250 and a function for stopping, during power supply, the supply in accordance with an instruction from the control unit 250.

During reception of power supplied from the power control unit 220, the power supply coil 230 forms a magnetic field and supplies power to the electric vehicle 400.

The vehicle communication unit 240 executes wireless communication with the electric vehicle 400. Upon receiving a temporary ticket from the electric vehicle 400, the vehicle communication unit 240 sends the temporary ticket to the control unit 250.

The control unit 250 controls the individual units in the power supply apparatus 200. Upon receiving a temporary ticket from the server communication unit 210, the control unit 250 stores the temporary ticket and causes the vehicle communication unit 240 to transmit a temporary ticket request signal. The control unit 250 receives a temporary ticket that the electric vehicle 400 transmits in response to the temporary ticket request signal and determines whether or not the received temporary ticket matches the stored temporary ticket. Upon determining that the received temporary ticket matches the stored temporary ticket, the control unit 250 instructs the power control unit 220 to start power supply to the power supply coil 230. When a certain time passes after the start of the power supply, the control unit 250 instructs the power control unit 220 so as to stop the power supply to the power supply coil 230.

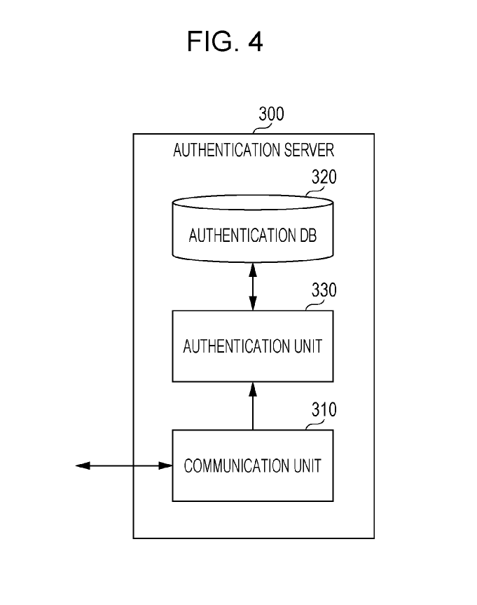

FIG. 4 is a functional block diagram of the authentication server 300.

As illustrated in FIG. 4, the authentication server 300 includes a communication unit 310, an authentication database (DB) 320, and an authentication unit 330.

The communication unit 310 communicates with the power-supply controller 100 or the electric vehicle 400 through the network 600.

The authentication DB 320 stores information needed for the authentication server 300 to perform authentication.

The authentication unit 330 controls the individual units in the authentication server 300. The authentication unit 330 authenticates, via the communication unit 310, the power-supply controller 100 or the electric vehicle 400 from which an authentication request is received. The authentication unit 330 reports the result of the authentication to the apparatus that issued the authentication request. Upon authenticating the power-supply controller 100, the authentication unit 330 transmits a power-supply-controller certificate to the power-supply controller 100 via the communication unit 310, and upon authenticating the electric vehicle 400, the authentication unit 330 transmits an electric-vehicle certificate to the electric vehicle 400 via the communication unit 310.

The power-supply-controller certificate is a certificate indicating that the authentication unit 330 has authenticated the power-supply controller 100. The electric-vehicle certificate is a certificate indicating that the authentication unit 330 has authenticated the electric vehicle 400. Upon receiving the power-supply-controller certificate or the electric-vehicle certificate, the authentication unit 330 performs authentication as whether or not the received certificate is a certificate transmitted by the power-supply controller 100 itself.

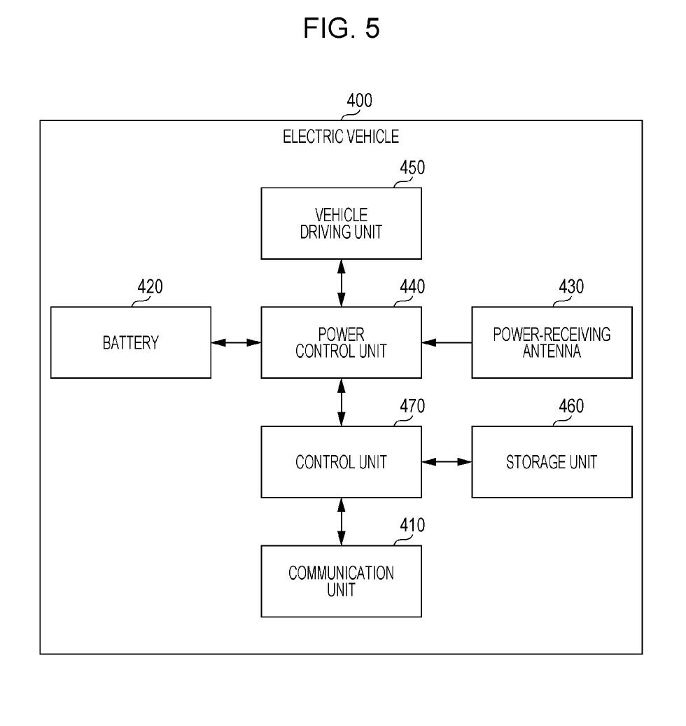

FIG. 5 is a functional block diagram of the electric vehicle 400.

The functional block diagram illustrated in FIG. 5 shows a functional configuration necessary for using the power supply system, and other functions (e.g., a control system for traveling) are not described hereinafter.

As illustrated in FIG. 5, the electric vehicle 400 includes a communication unit 410, a battery 420, a power-receiving antenna 430, a power control unit 440, a vehicle driving unit 450, a storage unit 460, and a control unit 470.

The communication unit 410 communicates with the authentication server 300 or the power supply apparatus 200 through the network 600.

The battery 420 has a function for charging a battery cell with supplied power and a function for discharging the accumulated power in accordance with an instruction from the power control unit 440.

The power-receiving antenna 430 receives power released from the power supply coil 230 of the power supply apparatus 200, the power supply coil 230 being embedded in a roadway, and supplies the received power to the power control unit 440.

The power control unit 440 supplies the power, sent from the power-receiving antenna 430, to the battery 420 to charge it. The power control unit 440 supplies the power, sent from the power-receiving antenna 430, or the power, accumulated in the battery 420, to the vehicle driving unit 450.

The vehicle driving unit 450 is equipment for driving the electric vehicle 400 with power supplied from the power control unit 440. The vehicle driving unit 450 is, for example, a motor for a vehicle.

The storage unit 460 stores a program and data needed for operation of the electric vehicle 400.

The control unit 470 controls the individual units in the electric vehicle 400. The control unit 470 issues an authentication request to the authentication server 300 via the communication unit 410. The control unit 470 stores a temporary ticket, sent from the communication unit 410, in the storage unit 460. In accordance with a temporary ticket request sent from the communication unit 410, the control unit 470 causes the communication unit 410 to transmit the temporary ticket, stored and held in the storage unit 460, to the power supply apparatus 200. The control unit 470 instructs the power control unit 440 so that the battery 420 is charged using the power-receiving antenna 430. The control unit 470 issues an instruction for supplying power to the vehicle driving unit 450.

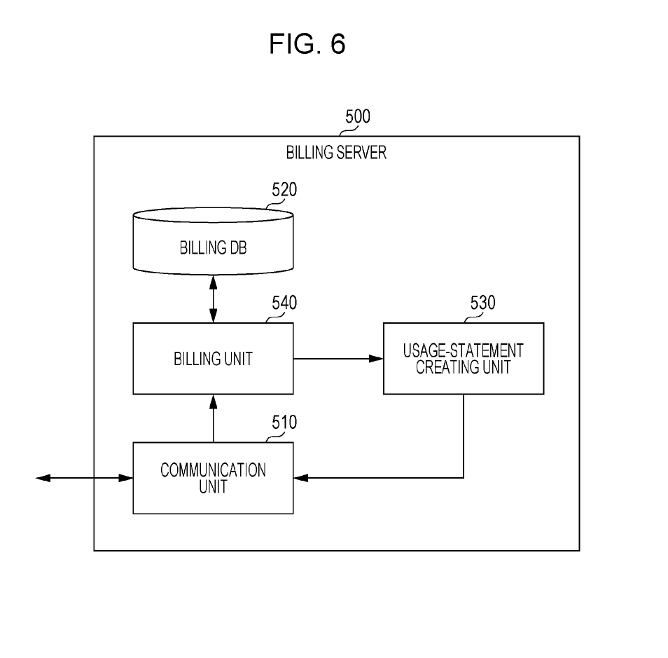

FIG. 6 is a functional block diagram of the billing server 500.

As illustrated in FIG. 6, the billing server 500 includes a communication unit 510, a billing DB 520, a usage-statement creating unit 530, and a billing unit 540.

The communication unit 510 communicates with the power-supply controller 100 or the electric vehicle 400 through the network 600.

The billing DB 520 stores data needed for the billing server 500 to bill the owner of an electric vehicle that uses the power supply system for the amount of power used.

In accordance with an instruction from the billing unit 540, the usage-statement creating unit 530 creates a usage statement for reporting the usage fee to the owner of the electric vehicle that used the power supply system. The usage-statement creating unit 530 transmits the created usage statement via the communication unit 510.

In accordance with either the amount of power supplied to the electric vehicle, the amount of power received by the electric vehicle, or both of the information, the billing unit 540 calculates a fee to be billed to the owner of the electric vehicle that used the power supply system. The billing unit 540 sends the calculated fee to be billed to the usage-statement creating unit 530. The fee to be billed may be distinguished for each road used or for each power supply apparatus installed on the road.

### <Data>

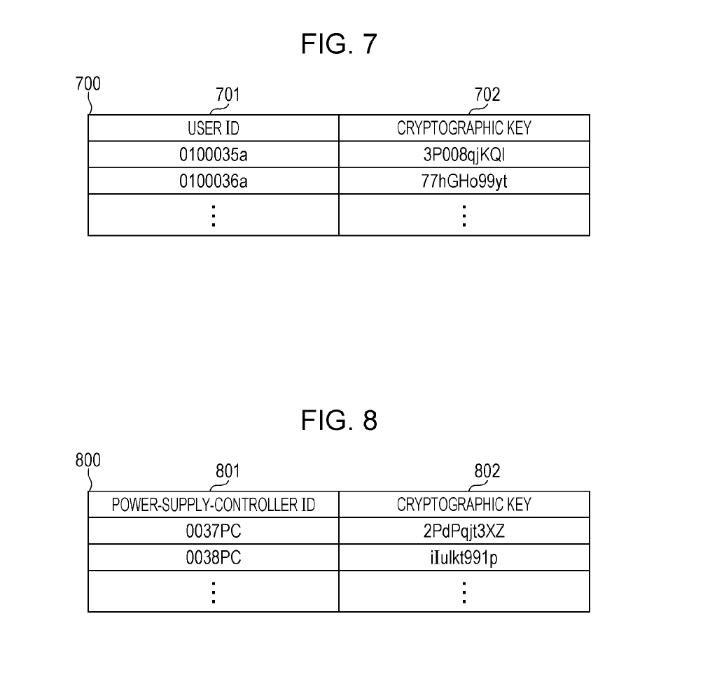

FIG. 7 is a conceptual table of electric-vehicle authentication data 700 that the authentication server 300 uses to perform authentication as to whether or not there is the legitimacy to use the power supply system. The electric-vehicle authentication data 700 is stored in the authentication DB 320.

The electric-vehicle authentication data 700 is information in which user identifiers (IDs) 701 and cryptographic keys 702 are associated with each other, as illustrated in FIG. 7.

Each user ID 701 is identification information indicating an electric vehicle that uses the power supply system or the owner of the electric vehicle.

Each cryptographic key 702 is stored in association with a corresponding user and is used for decoding information transmitted from a corresponding electric vehicle.

The authentication server 300 uses the corresponding cryptographic key 702 to decode information transmitted from the electric vehicle 400. Through the decoding, the authentication server 300 obtains a digital signature. The authentication server 300 performs authentication based on whether or not a user ID included in the digital signature and the user ID 701 included in the electric-vehicle authentication data 700 match each other.

FIG. 8 is a conceptual table of power-supply-controller authentication data 800 that the authentication server 300 uses to perform authentication as to whether or not a power-supply controller in the power supply system is legitimate. The power-supply-controller authentication data 800 is stored in the authentication DB 320.

The power-supply-controller authentication data 800 is information in which power-supply-controller IDs 801 and cryptographic keys 802 are associated with each other, as illustrated in FIG. 8.

Each power-supply-controller ID 801 is identification information used for identifying the corresponding power-supply controller 100 in the power supply system.

Each cryptographic key 802 is stored in association with the corresponding power-supply controller 100. Each cryptographic key 802 is used to decode information transmitted from the corresponding power-supply controller 100.

The authentication server 300 uses the corresponding cryptographic key 802 to decode information transmitted from the power-supply controller 100. Through the decoding, the authentication server 300 obtains a digital signature. The authentication server 300 performs authentication based on whether or not a power-supply-controller ID included in the obtained digital signature and the power-supply-controller ID 801 included in the power-supply-controller authentication data 800 match each other.

Authenticating the power-supply controller 100 makes it possible to prevent impersonation of the power-supply controller 100 in the power supply system and makes it possible to prevent theft of electricity.

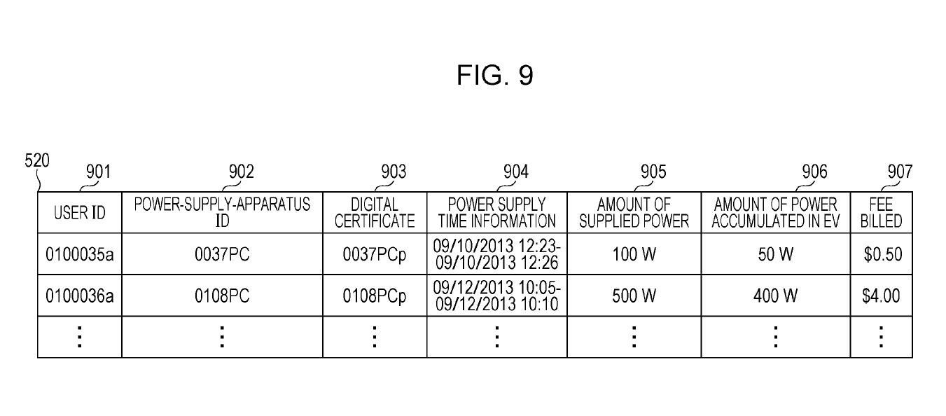

FIG. 9 is a conceptual table of the billing DB 520 that the billing server 500 uses in order to bill the user of an electric vehicle that uses the power supply system.

As illustrated in FIG. 9, user IDs 901, power-supply-apparatus IDs 902, digital certificates 903, power-supply time information 904, amounts of supplied power 905, amounts of power accumulated in EV 906, and fees billed 907 are associated in the billing DB 520.

Each user ID 901 is an identifier of a user who owns an electric vehicle and uses the power supply system to execute charging.

Each power-supply-apparatus ID 902 is an identifier of a power supply apparatus used by the electric vehicle of a user having a corresponding user ID.

Each digital certificate 903 is information of a digital certificate for a corresponding user ID.

The power-supply time information 904 is information indicating date and time when a corresponding power supply apparatus supplies power to the electric vehicle of a corresponding user.

Each amount of supplied power 905 is information indicating the amount of power that a power supply apparatus supplied to the electric vehicle of a corresponding user.

Each amount of power accumulated in EV 906 is information indicating the amount of power with which an electric vehicle is charged using the power supply system.

The fee billed 907 indicates, to a corresponding user, a usage fee for reception of a charging service using the power supply system.

A detailed scheme for the billing is described in conjunction with a third embodiment described below.

### <Operations>

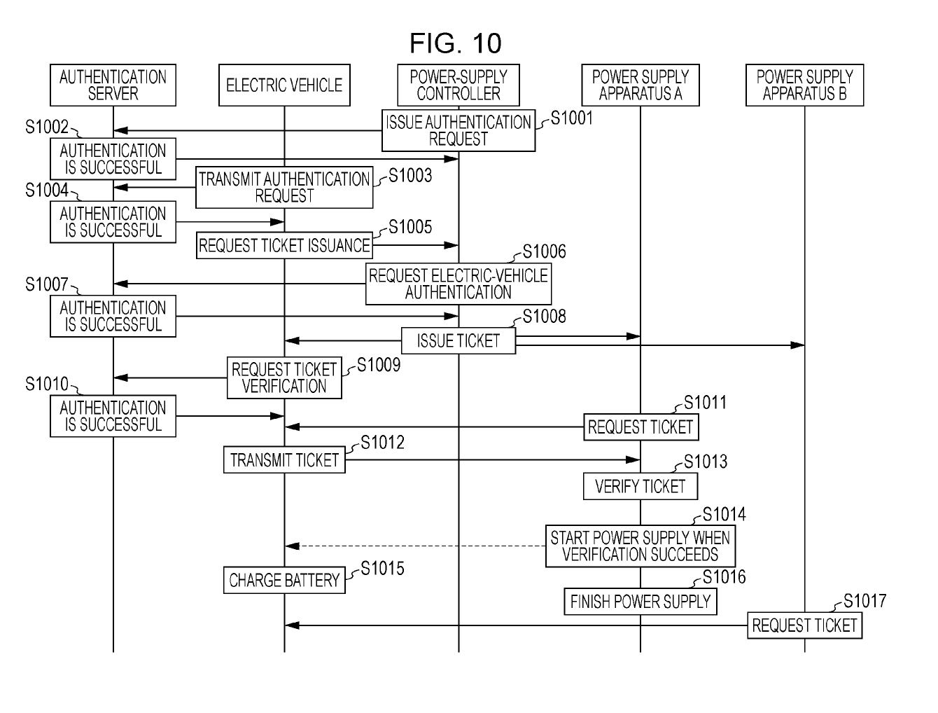

FIG. 10 is a sequence diagram of operations of the power supply system in the first embodiment. FIG. 10 illustrates a flow from when an electric vehicle is authenticated until it receives power that is supplied.

First, the control unit 140 in the power-supply controller 100 issues an authentication request to the authentication server 300 through the communication unit 110 and the network 600 (step S1001). This authentication request includes information obtained by the control unit 140 encrypting the digital signature of the power-supply controller 100, the digital signature being stored in the storage unit 120, by using a pre-defined cryptographic key. The authentication in response to the authentication request may be executed on a regular basis or may be executed only when the power-supply controller 100 is started. However, the authentication is performed before power is supplied to the electric vehicle.

Upon receiving the authentication request, the authentication unit 330 in the authentication server 300 refers to the power-supply-controller authentication data 800 stored in the authentication DB 320 to identify a cryptographic key corresponding to the power-supply controller 100. The authentication unit 330 then uses the identified cryptographic key 802 to decode encrypted information included in the authentication request. The authentication unit 330 determines whether or not a power-supply controller indicated by the digital signature resulting from the decoding is the power-supply controller that issued the authentication request. If the determination indicates an affirmative result, the authentication unit 330 sends, to the power-supply controller, a power-supply-controller certificate indicating that the power-supply controller is legitimate (step S1002). If the determination indicates a negative result, the authentication server 300 sends a notification to that effect to the power-supply controller 100.

On the other hand, the electric vehicle 400 that uses the power supply system also performs authentication before receiving power from the power supply system. The control unit 470 in the electric vehicle 400 reads a digital certificate and a cryptographic key from the storage unit 460. The control unit 470 encrypts the read digital certificate by using the read cryptographic key. The control unit 470 adds information resulting from the encryption to an authentication request and transmits the authentication request to the authentication server 300 through the communication unit 410 and the network 600 (step S1003).

Upon receiving the authentication request from the electric vehicle 400, the authentication unit 330 in the authentication server 300 refers to the electric-vehicle authentication data 700 stored in the authentication DB 320 to identify a cryptographic key corresponding to the electric vehicle 400. The authentication unit 330 then uses the identified cryptographic key 702 to decode encrypted information included in the authentication request. The authentication unit 330 determines whether or not an electric vehicle indicated by a digital signature resulting from the decoding is the electric vehicle that issues the authentication request. If the determination indicates an affirmative result, the authentication unit 330 transmits, to the electric vehicle, an electric-vehicle certificate indicating that the electric vehicle is legitimate (step S1004). If the determination indicates a negative result, the authentication server 300 issues a notification to that effect to the electric vehicle 400.

When the power supply system is to be used, the control unit 470 in the electric vehicle 400 transmits a ticket issuance request to the power-supply controller 100 (step S1005). This ticket issuance request includes the electric-vehicle certificate received from the authentication server 300.

Upon receiving the ticket issuance request, the power-supply controller 100 requests the authentication server 300 to perform authentication as to whether or not the electric-vehicle certificate included in the ticket issuance request is legitimate (step S1006).

Upon receiving the authentication request, the authentication server 300 verifies whether or not the received electric-vehicle certificate is a certificate issued by the authentication server 300 itself. If the electric-vehicle certificate is a certificate issued by the authentication server 300 itself, the authentication server 300 notifies the power-supply controller 100 that the authentication is successful (step S1007).

Upon receiving the notification indicating that the authentication is successful, the control unit 140 in the power-supply controller 100 requests the temporary ticket issuing unit 130 so as to issue a temporary ticket. The temporary ticket issuing unit 130 issues a temporary ticket for the electric vehicle 400. The temporary ticket issuing unit 130 transmits the temporary ticket (a first temporary ticket) to the electric vehicle 400. The temporary ticket issuing unit 130 also transmits a temporary ticket (a second temporary ticket) to a power supply apparatus connected to the power-supply controller 100 (step S1008).

The temporary ticket includes a power-supply-controller certificate for the power-supply controller 100.

Upon receiving the temporary ticket, the electric vehicle 400 transmits the power-supply-controller certificate included in the temporary ticket to the authentication server 300 and requests it to verify whether or not the temporary ticket is legitimate (step S1009).

The authentication unit 330 in the authentication server 300 verifies whether or not the received power-supply-controller certificate is a certificate issued by the authentication unit 330 itself. If the authentication is successful, the authentication unit 330 transmits a notification to that effect to the electric vehicle 400 (step S1010). If the authentication is not successful, the authentication unit 330 transmits a notification to that effect to the electric vehicle 400. In this case, the electric vehicle 400 transmits a ticket request to another power-supply controller again, and the processing is performed again from the beginning (step S1005).

On the other hand, a power supply apparatus (a power supply apparatus A in FIG. 10) that has received the temporary ticket stores the temporary ticket and transmits a temporary ticket request signal for requesting a temporary ticket to the electric vehicle 400, as needed (step S1011).

Upon receiving the temporary ticket request signal, the electric vehicle 400 transmits the temporary ticket, received from the power-supply controller 100, to the power supply apparatus A that transmitted the temporary ticket request signal (step S1012).

The control unit 250 in the power supply apparatus A that has received the temporary ticket from the electric vehicle 400 via the vehicle communication unit 240 determines whether or not the received temporary ticket matches the temporary ticket received from the power-supply controller 100 in advance (step S1013). If the temporary tickets match each other, the control unit 250 causes the power control unit 220 to start power supply to the power supply coil 230 (step S1014). As a result, power is wirelessly transmitted from the power supply coil 230 and is received by the power-receiving antenna 430 of the electric vehicle 400, so that the battery 420 is charged (step S1015).

Thereafter, after a certain time passes, the control unit 250 instructs the power control unit 220 to stop the power supply and finishes the wireless electric-power transmission from the power supply apparatus A (step S1016).

Also, when the electric vehicle 400 approaches a power supply apparatus B, the electric vehicle 400 receives a temporary ticket request signal transmitted from the power supply apparatus B (step S1017). Thereafter, processing similar to that of the power supply apparatus A is performed with the electric vehicle 400.

When the power supply system is used in a manner described above, the billing server 500 bills the owner of the electric vehicle 400 for the usage fee.

As described above, in the power supply system according to the first embodiment, an electric vehicle is authenticated in advance, and in actual power supply, authentication is performed by verifying a match of the temporary ticket, and the power supply is triggered by transmission/reception of the temporary ticket. Accordingly, even when an advanced, complicated algorithm is used to perform authentication as to whether or not the electric vehicle has the legitimacy to receive power supply, power supply to the electric vehicle can be started in a short time in a section where the power supply apparatus is installed. Thus, according to the first aspect, it is possible to start power supply in a short time while performing highly reliable authentication.

In addition, in the power supply system according to the first embodiment, the power supply apparatus may delete the temporary ticket (the second temporary ticket) after the electric vehicle passes through a section where the power supply apparatus is installed for a roadway. With this arrangement, even if a third party intercepts the temporary ticket, the intercepted temporary ticket is deleted. Thus, in the section where the power supply apparatus is installed, it is possible to prevent theft of electricity by a third party or power supply due to impersonation.

### Second Embodiment

In the first embodiment, a description has been given of an example of the system in which the power supply apparatus controls one power supply coil. In a second embodiment, a description will be given of an example of a system in which the power supply apparatus controls a plurality of power supply coils to execute power supply to the electric vehicle.

### <Configuration>

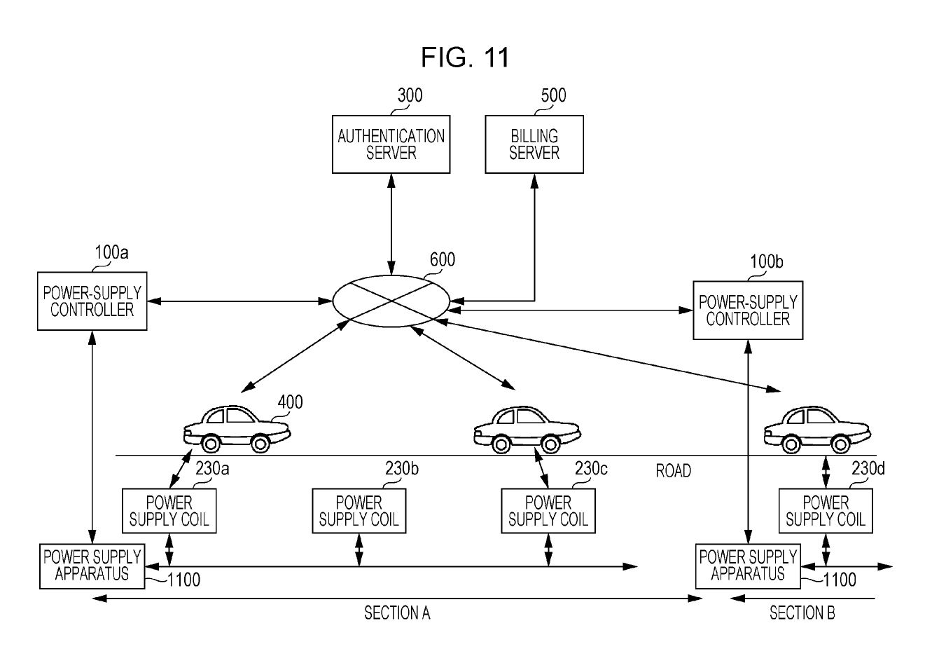

FIG. 11 is a system diagram illustrating the configuration of a power supply system according to the second embodiment. As illustrated in FIG. 11, power supply coils 230a, 230b, and 230c are connected to power supply apparatuses 1100. Each of the power supply coils 230a, 230b, and 230c receives power supplied from the corresponding power supply apparatus 1100 and wirelessly transmits power.

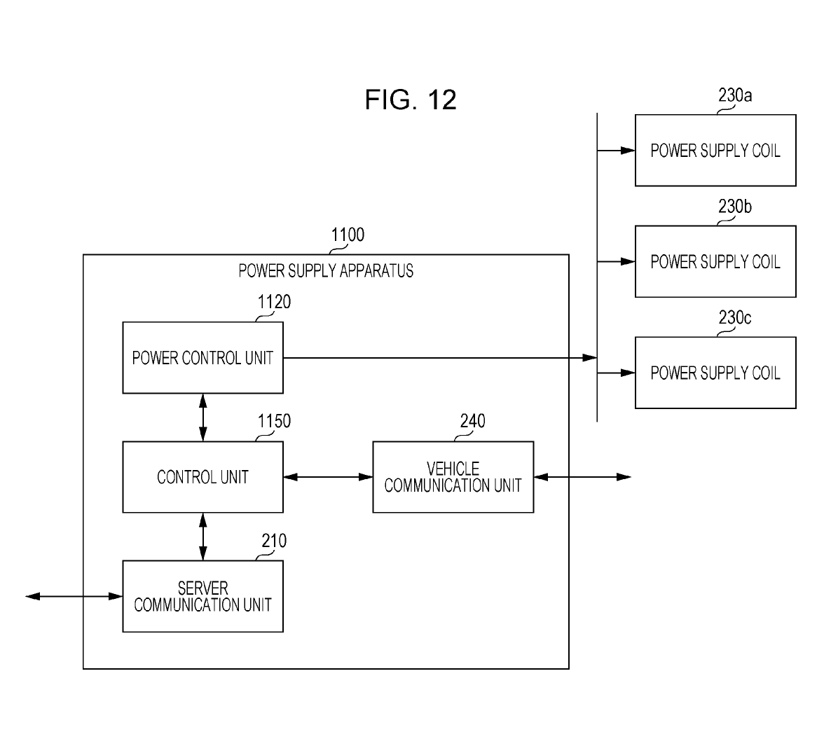

FIG. 12 is a functional block diagram of each power supply apparatus 1100 according to the second embodiment. Functional units having functions that are the same as or similar to those in the power supply apparatus 200 described in the first embodiment are denoted by the same reference numerals, and descriptions thereof are not given hereinafter.

As illustrated in FIG. 12, a power control unit 1120 in the power supply apparatus 1100 is connected to the plurality of power supply coils 230a, 230b, and 230c, unlike the power supply apparatus 200 in the first embodiment. Although an example in which the power control unit 1120 is connected to three power supply coils is illustrated for the sake of convenience, the number of power supply coils to which the power control unit 1120 is connected is not limited to three and may be any number. In addition to the functions of the control unit 250 in the power supply apparatus 200, the power supply apparatus 1100 has a control unit 1150 having a function for giving an instruction about control information of each power supply coil to the power control unit 1120.

In accordance with an instruction from the control unit 1150, the power control unit 1120 in the power supply apparatus 1100 supplies power to a selected one of the power supply coils 230a, 230b, and 230c at a specified timing.

In accordance with a power-supply request received from the electric vehicle 400 via the vehicle communication unit 240, the control unit 1150 issues an instruction for supplying power to the power control unit 1120. At this point, on the basis of current location information, travel-speed information, and scheduled travel-route information of the electric vehicle 400, the information being included in the power-supply request, the control unit 1150 predicts the timing at which the electric vehicle 400 passes on each power supply coil.

In this case, the control unit 1150 determines the time at which the electric vehicle 400 starts to pass on each power supply coil and the time at which the electric vehicle 400 completes the passing, assuming that the electric vehicle 400 travels at a constant speed.

Now, a method for determining a predicted position will be described briefly. Suppose that the travel-speed information of the electric vehicle 400 is X km/h, and the distance from the current location of an electric vehicle which is indicated by the current location information to an end portion of the power supply coil which is located at the electric vehicle side is Y km. In this case, the time taken until the electric vehicle arrives at the power supply coil is given by X×60/Y minutes. A time obtained by adding this value to the time at which the power-supply request is received is a passage start time at which the electric vehicle starts to pass by the power supply coil. Thus, the control unit 1150 instructs the power control unit 1120 so as to supply power to that power supply coil a few seconds earlier than the passage start time. The few seconds earlier than the determined time is specified considering the time loss from when a power-supply request is transmitted from the electric vehicle 400 until it arrives at the power supply apparatus 1100.

Similarly, when the length of the power supply coil is given by Z km, the time from when the electric vehicle starts to travel on the power supply coil until it completes the traveling is given by Z×60/X minutes. This time is added to the passage start time to yield a passage completion time. The control unit 1150 sends the passage completion time to the power control unit 1120, and the power control unit 1120 finishes the power supply to the power supply coil at the passage completion time. For the passage completion time, a few seconds after the determined passage completion time may be set as the actual power supply completion time.

The functions of the power supply apparatus 1100 according to the second embodiment have been described thus far.

### <Operation>

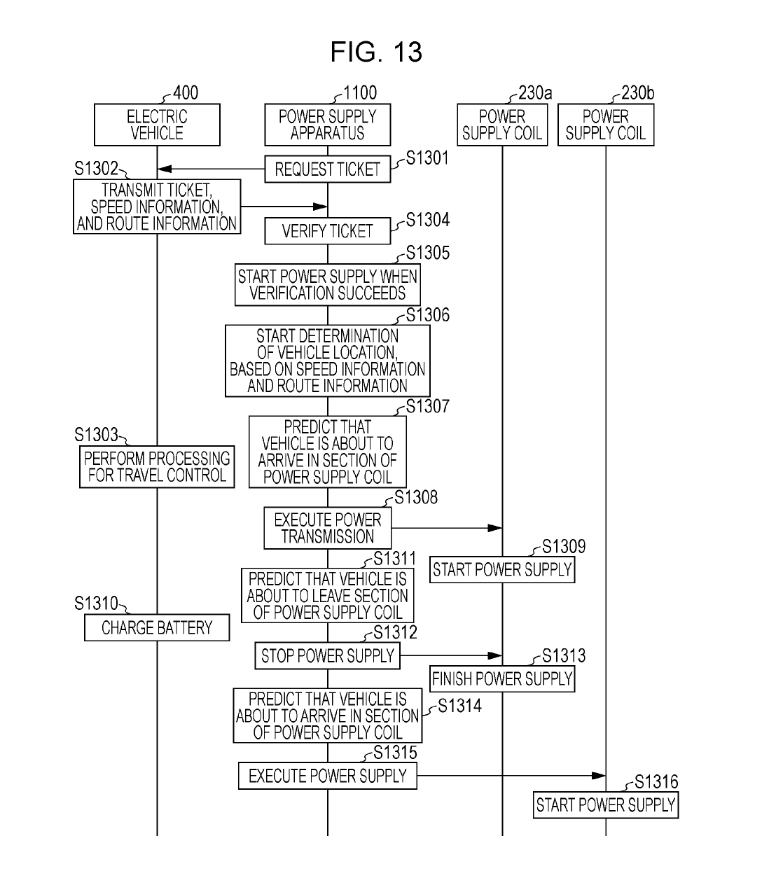

Now, a description will be given of operations of the power supply system according to the second embodiment. FIG. 13 is a sequence diagram illustrating operations of the power supply system according to the second embodiment. Since the processing until the electric vehicle 400 transmits a power-supply request to the power supply apparatus (i.e., from when the electric vehicle 400 receives a temporary ticket request from the power supply apparatus until it transmits a temporary ticket) is analogous to that in the first embodiment, processing subsequent to the above-described processing will be described.

As illustrated in FIG. 13, the power supply apparatus 1100 issues a request for a temporary ticket to the electric vehicle 400 (step S1301).

Upon receiving the request, the electric vehicle 400 transmits a temporary ticket held in the storage unit 460, travel-speed information obtained from the vehicle driving unit 450, and scheduled-travel-route information (step S1302). The user pre-sets a destination for the electric vehicle, and routes that connect to the set destination are searched for to thereby obtain the travel-route information. The travel-route information is obtained from, for example, the so-called vehicle navigation system included in the electric vehicle 400. Thereafter, the electric vehicle 400 travels in accordance with driving performed by the driver thereof (step S1303).

The control unit 250 in the power supply apparatus 1100 verifies whether or not the temporary ticket received from the electric vehicle 400 and a temporary ticket delivered from the power-supply controller 100 in advance match each other (step S1304).

If the temporary ticket received from the electric vehicle 400 and the temporary ticket received from the power-supply controller 100 match each other, the power supply apparatus 200 starts power supply (step S1305).

After finishing the temporary ticket verification, the control unit 250 in the power supply apparatus 200 starts prediction of the travel position of the electric vehicle 400, based on the received travel-speed information and travel-route information (step S1306).

The control unit 250 in the power supply apparatus 200 predicts the time at which the electric vehicle 400 arrives at the end portion of each connected power supply coil and the time at which the electric vehicle 400 finishes traveling on the connected power supply coil. That is, the control unit 250 determines the passage start time and the passage completion time of the electric vehicle 400 with respect to each of the power supply coils 230a, 230b, and 230c.

When the determined passage start time for the power supply coil 230a is reached according to the prediction, the control unit 250 predicts that the electric vehicle 400 is about to arrive in the section where the power supply coil 230a is installed (step S1307).

The control unit 250 then instructs the power supply coil 230a in the power control unit 220 so as to start power supply. Upon receiving the instruction, the power control unit 220 starts transmitting power to the power supply coil 230a (step S1308). The power supply coil 230a then starts power supply to the electric vehicle 400 (step S1309).

The electric vehicle 400 receives the power wirelessly transmitted from the power supply coil 230a via the power-receiving antenna 430 and executes charging of the battery 420 (step S1310).

Next, when the pre-determined passage completion time for the power supply coil 230a is reached, the control unit 250 in the power supply apparatus 200 predicts that it is the time at which the electric vehicle 400 is about to leave the section where the power supply coil 230a is installed (step S1311).

As a result, the control unit 250 in the power supply apparatus 200 instructs the power control unit 220 so as to finish power supply to the power supply coil 230a. In response to the instruction, the power control unit 220 finishes transmitting power to the power supply coil 230a (step S1312), and the power supply coil 230a finishes the wireless power transmission (step S1313).

Next, when the passage start time of the power supply coil 230b is reached, the control unit 250 in the power supply apparatus 200 predicts that the electric vehicle 400 is about to arrive in the section where the power supply coil 230b is installed (step S1314).

Thus, the control unit 250 instructs the power control unit 220 so as to start power supply to the power supply coil 230a. In response to the instruction, the power control unit 220 starts transmitting power to the power supply coil 230a (step S1315). The power supply coil 230a then starts power supply to the electric vehicle 400 (step S1316).

Thereafter, the power supply apparatus 200 executes processing in steps S1307 to S1312 on each power supply coil.

Through the processing, in the power supply system, since power supply can be performed with an appropriate timing being predicted for each power supply coil, it is possible to prevent execution of unwanted passage of electrify to the power supply coil. As a result, it is possible to prevent loss due to the passage of electrify and it is also possible to avoid an event in which an electric vehicle that is not eligible to use the power supply system steals electricity.

### Third Embodiment

In each of the first and second embodiments, a system in which power is supplied to a traveling electric vehicle has been described. A scheme in which billing is performed in such a system and fraud for the billing can be prevented will be disclosed in a third embodiment.

If any fraud occurs, it can occur when billing is performed according to the amount of power received by an electric vehicle. That is, there are cases in which an electric vehicle reports a small amount of power as the amount of received power and billing is performed according to the reported small amount of power. This means that a business operator that operates the power supply system cannot collect a regular fee.

When power cannot be efficiently supplied from a power supply coil to the power-receiving antenna of an electric vehicle, performing billing based simply on the amount of supplied power can make the recipient of the power feel unfairness.

Accordingly, a power supply system than can perform billing as correctly as possible so that the recipient of power does not feel unfairness will be disclosed in the third embodiment. A system configuration in the third embodiment will be described in connection with the example described above in the first embodiment and illustrated in FIG. 1. The description below will be given of power supply examples 1 to 3 in which the power supply system stops power supply when it is determined that inefficient charging is performed, in order that the user of an electric vehicle does not feel unfairness due to billing based on the inefficient charging. Processing from when the power supply is started will be described in power supply examples 1 to 3, and descriptions of authentication and so on up to the processing are not given hereinafter, since they are substantially the same as those described in the first embodiment.

### Power Supply Example 1

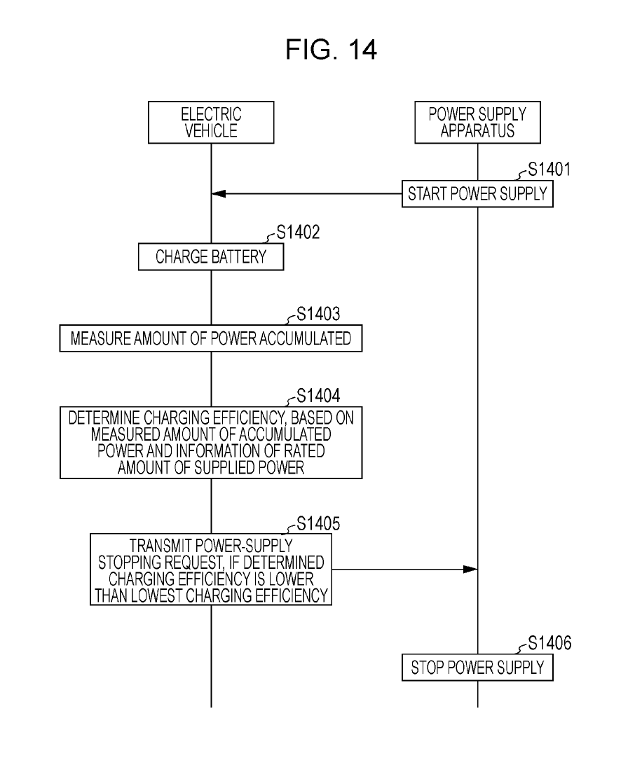

FIG. 14 is a sequence diagram illustrating communication between the power supply apparatus 200 and the electric vehicle 400 in power supply example 1.

The power supply apparatus 200 starts power supply to the electric vehicle 400 (step S1401).

The power-receiving antenna 430 of the electric vehicle 400 receives power wirelessly transmitted from the power supply apparatus 200. The power control unit 440 charges the battery 420 with the received power (step S1402).

The power control unit 440 then measures the amount of power accumulated for a certain period time (step S1403). In this case, for example, the power control unit 440 measures the amount of power accumulated for 10 seconds from when the charging is started. The power control unit 440 reports the measured amount of accumulated power to the control unit 470.

The control unit 470 determines a charging efficiency on the basis of the reported amount of accumulated power and information of a rated amount of power supplied (step S1404). The information of the rated amount of power supplied is information pre-stored in the storage unit 460 or information transmitted from a power supply apparatus and indicates the amount of power supplied per unit time during power supply.

The control unit 470 compares the determined charging efficiency with a lowest charging efficiency. If the determined charging efficiency is lower than the lowest charging efficiency, the control unit 470 transmits, to the power supply apparatus 200, a power-supply stopping request for requesting stopping of the power supply (step S1405).

When the power supply apparatus 200 receives the power-supply stopping request, the power control unit 220 in the power supply apparatus 200 suspends applying power to the power supply coil 230 to thereby stop the power supply (step S1406).

### Power Supply Example 2

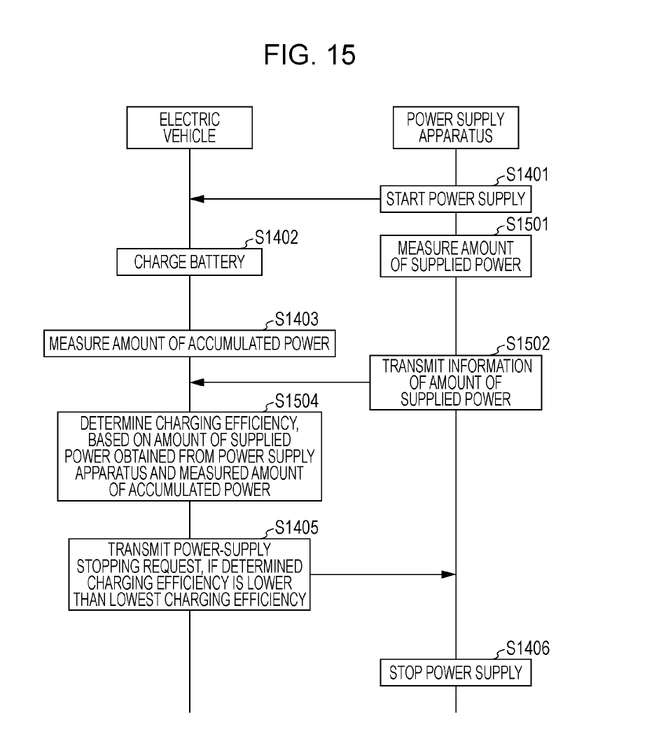

FIG. 15 is a sequence diagram illustrating communication between the power supply apparatus 200 and the electric vehicle 400 in power supply example 2. In FIG. 15, processes that are analogous to those in FIG. 14 are denoted by the same reference numerals.

As illustrated in FIG. 15, the power supply apparatus 200 starts power supply to the electric vehicle 400 (step S1401).

The power-receiving antenna 430 of the electric vehicle 400 receives power wirelessly transmitted from the power supply apparatus 200. The power control unit 440 charges the battery 420 with the received power (step S1402).

The power control unit 440 measures the amount of power accumulated for a certain period of time from when the charging is started (step S1403). In this case, for example, the power control unit 440 measures the amount of power accumulated for 10 seconds from when the charging is started. The power control unit 440 reports the measured amount of accumulated power to the control unit 470.

The power control unit 220 in the power supply apparatus 200 also measures the amount of power supplied for a certain period of time from when the power supply is started (step S1501). In this case, for example, the power control unit 220 measures the amount of power supplied for 10 seconds from when the power supply is started. The power control unit 220 reports the measured amount of supplied power to the control unit 250.

The control unit 250 transmits information of the reported amount of supplied power to the electric vehicle 400 via the vehicle communication unit 240 (step S1502).

When the electric vehicle 400 receives the amount of supplied power from the power supply apparatus 200, the control unit 470 in the electric vehicle 400 determines a charging efficiency on the basis of the received amount of supplied power and the measured amount of accumulated power (step S1504).

The control unit 470 compares the determined charging efficiency with a lowest charging efficiency. If the determined charging efficiency is lower than the lowest charging efficiency, the control unit 470 transmits a power-supply stopping request to the power supply apparatus 200 (step S1405).

When the power supply apparatus 200 receives the power-supply stopping request, the power control unit 220 in the power supply apparatus 200 suspends applying power to the power supply coil 230 to thereby stop the power supply (step S1406).

### Power Supply Example 3

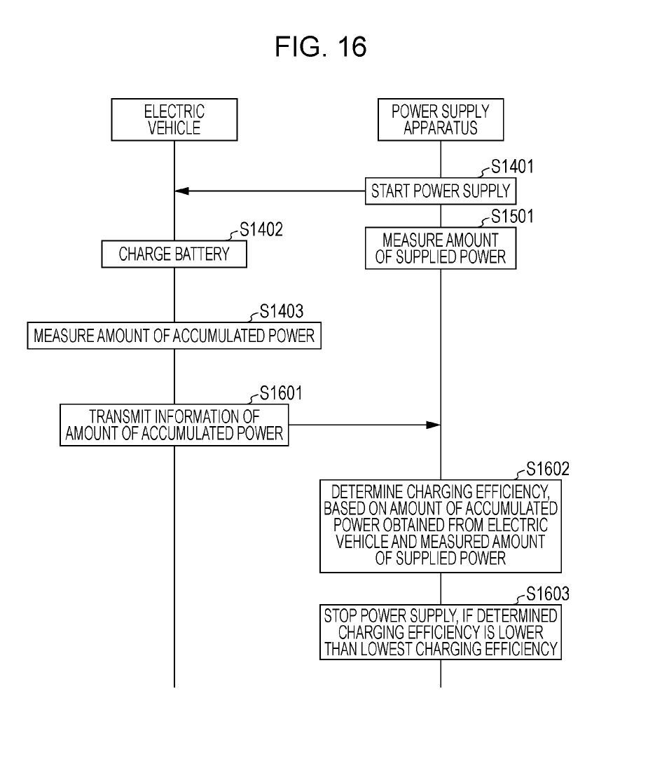

FIG. 16 is a sequence diagram illustrating communication between the power supply apparatus 200 and the electric vehicle 400 in power supply example 3. In FIG. 16, processes that are analogous to those in FIG. 15 are denoted by the same reference numerals.

As illustrated in FIG. 16, the power supply apparatus 200 starts power supply to the electric vehicle 400 (step S1401).

The power-receiving antenna 430 of the electric vehicle 400 receives power wirelessly transmitted from the power supply apparatus 200. The power control unit 440 then charges the battery 420 with the received power (step S1402).

The power control unit 440 then measures the amount of power accumulated for a certain period of time from when the charging is started (step S1403). In this case, for example, the power control unit 440 measures the amount of power accumulated for 10 seconds from when the charging is started. The power control unit 440 reports the measured amount of accumulated power to the control unit 470.

The control unit 470 transmits the reported amount of accumulated power to the power supply apparatus 200 via the communication unit 410 (step S1601).

The power control unit 220 in the power supply apparatus 200 measures the amount of power supplied for a certain period of time from when the power supply is started (step S1501). In this case, for example, the power control unit 220 measures the amount of power supplied for 10 seconds from when the power supply is started. The power control unit 220 reports the measured amount of supplied power to the control unit 250.

Upon receiving the amount of accumulated power from the electric vehicle 400, the control unit 250 in the power supply apparatus 200 determines a charging efficiency of the electric vehicle 400 on the basis of the received amount of accumulated power and the measured amount of supplied power (step S1602).

The control unit 250 compares the determined charging efficiency with a lowest charging efficiency. If the determined charging efficiency is lower than the lowest charging efficiency, the control unit 250 instructs the power control unit 220 so as to stop the power supply. In response to the instruction, the power control unit 220 stops the power supply to the power supply coil 230 (step S1603).

When the charging becomes inefficient, the power supply from the power supply apparatus is stopped, as described above in power supply examples 1 to 3. Thus, it is possible to prevent the electric vehicle from being wrongfully billed for the power fee.

### <Billing Processing>

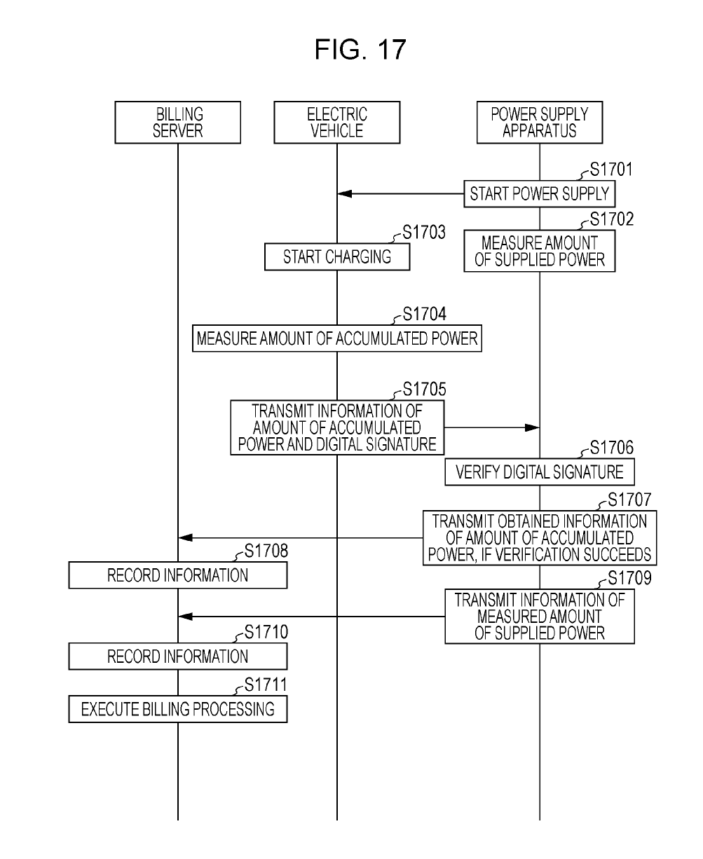

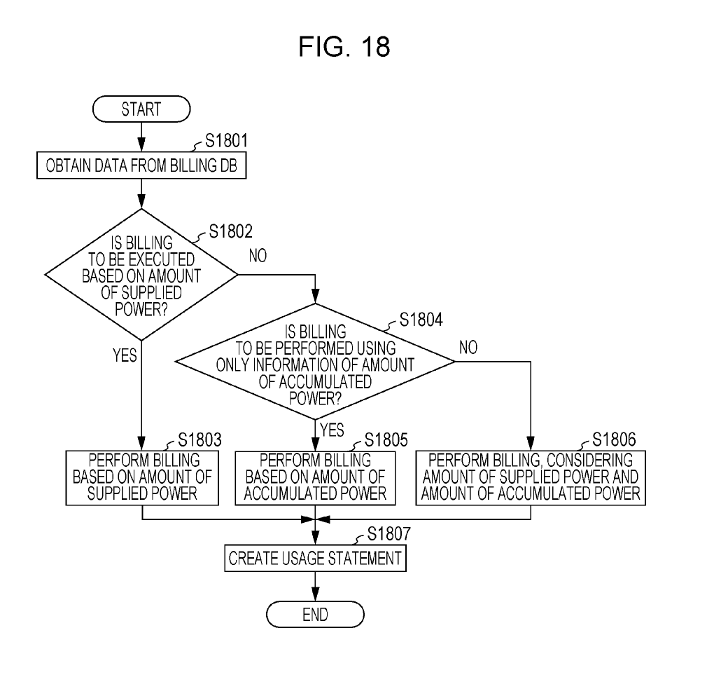

FIG. 17 is a sequence diagram illustrating billing processing in the power supply system, and FIG. 18 is a flowchart illustrating operations of the billing server 500. Billing in the power supply system will now be described with reference to FIGS. 17 and 18.

The sequence diagram illustrated in FIG. 17 shows a flow from when the power supply apparatus starts power supply to an electric vehicle until billing processing is performed.

The power supply apparatus 200 starts power supply to the electric vehicle 400 (step S1701).

Simultaneously with starting the power supply, the power control unit 220 in the power supply apparatus 200 starts measurement of the amount of power supplied (step S1702). The “amount of power supplied” in this case refers to the amount of power supplied from the start to the end of the power supply that the power supply apparatus 200 performs on the electric vehicle 400.

The electric vehicle 400 receives power wirelessly transmitted from the power supply coil 230 in the power supply apparatus 200 via the power-receiving antenna 430, and the power control unit 440 charges the battery 420 with the received power (step S1703).

The power control unit 440 in the electric vehicle 400 then measures the amount of power accumulated from the start of the charging until the end of the charging (step S1704).

When the charging is finished, the control unit 470 in the electric vehicle 400 receives the measured amount of accumulated power from the power control unit 440 and transmits information of the amount of accumulated power, together with a digital signature of the electric vehicle 400, to the power supply apparatus 200 (step S1705).

The power supply apparatus 200 verifies the digital signature received from the electric vehicle 400 (step S1706).

If the power supply apparatus 200 determines that the received amount of accumulated power is legitimate through the verification of the digital signature, the power supply apparatus 200 transmits information of the amount of accumulated power to the billing server 500 (step S1707).

The billing server 500 records the transmitted information to the billing DB 520 (step S1708).

The power supply apparatus 200 transmits the measured amount of supplied power to the billing server 500 (step S1709).

The billing server 500 records the transmitted information in a corresponding portion in the billing DB 520 (step S1710).

The billing server 500 executes billing processing on the basis of at least one of the amount of power supplied to the electric vehicle 400, the information of the amount of power being received from the power supply apparatus 200, and the amount of accumulated power measured by the electric vehicle 400 (step S1711).

FIG. 18 is a flowchart illustrating operations of the billing server 500 for the billing processing.

As illustrated in FIG. 18, the billing unit 540 in the billing server 500 refers to the billing DB 520 to obtain information about a user ID, a power-supply-apparatus ID, date-and-time information, the amount of supplied power, and the amount of accumulated power (step S1801).

The billing unit 540 determines whether or not billing is to be executed based only on the amount of supplied power (step S1802). This determination is made based on whether or not a digital signature of a user (or an electric vehicle) corresponding to the user ID is associated with the obtained information.

If there is no digital signature, the billing unit 540 determines that billing is to be performed based only on the amount of supplied power (YES in step S1802) and calculates a fee to be billed, based only on the amount of supplied power obtained from the billing DB 520 (step S1803).

If billing is not performed based only on the amount of supplied power (NO in step S1802), the billing unit 540 determines whether or not billing is to be performed based only on the amount of accumulated power (step S1804). This determination is made according to settings pre-specified between the user and the power supply system.

If the billing unit 540 determines that billing is to be performed based only on the amount of accumulated power (YES in step S1804), the billing unit 540 calculates a fee to be billed, based only on the amount of accumulated power obtained from the billing DB 520 (step S1806).

If billing is not to be performed based only on the amount of accumulated power (NO in step S1804), the billing unit 540 calculates a fee to be billed, based on the obtained amount of supplied power and amount of accumulated power (step S1806). More specifically, the billing unit 540 calculates an intermediate value between the obtained amount of supplied power and the obtained amount of accumulated power and calculates a fee to be billed by using the intermediate value (step S1807).

Upon calculating the fee to be billed to the user, the billing unit 540 reports the fee to be billed and information about the user who is to be billed to the usage-statement creating unit 530. The usage-statement creating unit 530 creates a usage statement made out to the reported user to request the reported fee to be billed (step S1808).

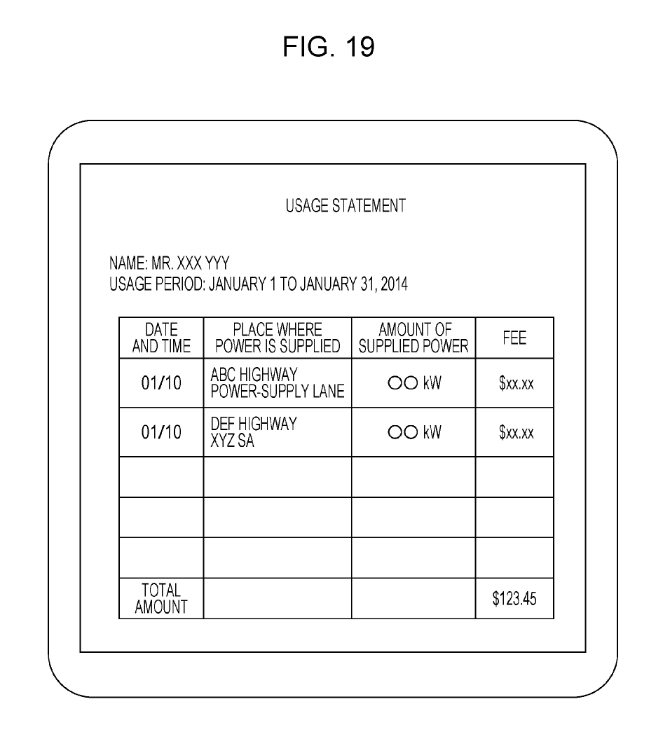

The usage statement is created, for example, in a manner as illustrated in FIG. 19. In the usage statement, information for identifying a user and/or a place where power is supplied are/is identified based on the user ID and/or the power-supply-apparatus ID in the billing DB 520.

The usage statement created by the usage-statement creating unit 530 is sent to the communication unit 510 and is transmitted to the electric vehicle 400 of the user or a portable terminal or a personal computer (PC) of the user through the network 600.

Payment for the billed fee may be made in various forms, such as withdrawal from a bank, bank transfer by the user, or the like, and the payment is executed using a method selected by the user.

### Fourth Embodiment

In the embodiment described above, a system in which power is supplied to a traveling electric vehicle has been described. A scheme for increasing the amount of power supplied to an electric vehicle per unit time is disclosed in a fourth embodiment.

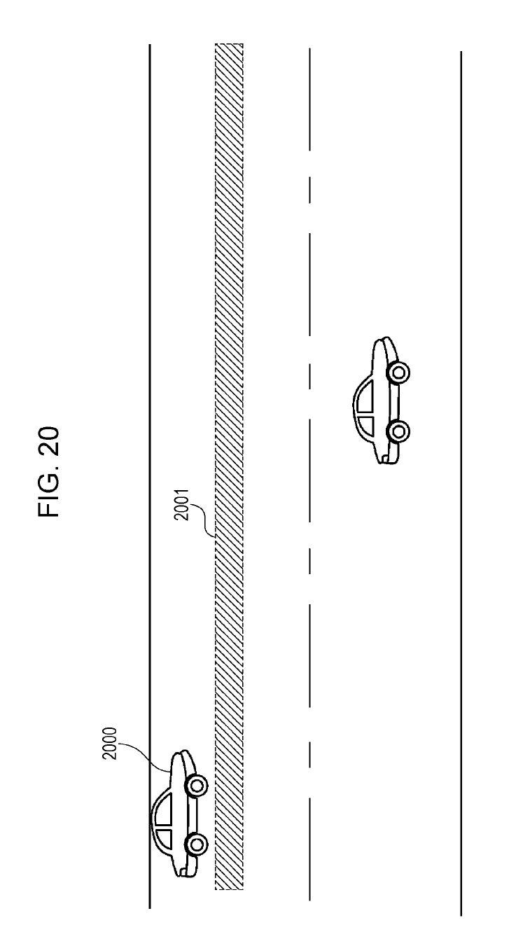

FIG. 20 is a diagram illustrating an external appearance example of a power supply system according to the fourth embodiment. As illustrated in FIG. 20, in the power supply system, an electric vehicle 2000 receives power supplied by traveling on a roadway in which a power supply coil 2001 is embedded.

During the power supply, naturally, since the width of the roadway is larger than that of the electric vehicle 2000, there are cases in which the electric vehicle 2000 travels on the right or left side of the roadway. In such cases, the distance between the power supply coil 2001 and the power-receiving antenna of the electric vehicle 2000 increases, and thus the possibility that the power-receiving efficiency decreases is high.

Accordingly, in such cases, a driving method by which the power-receiving efficiency of the electric vehicle 2000 increases is presented to the driver, thereby increasing the amount of power supplied per unit time.

### <Configuration>

In the power supply system according to the fourth embodiment, a line marker indicating that a power supply coil 2001 is embedded immediately below a roadway is applied to the roadway above the power supply coil 2001.

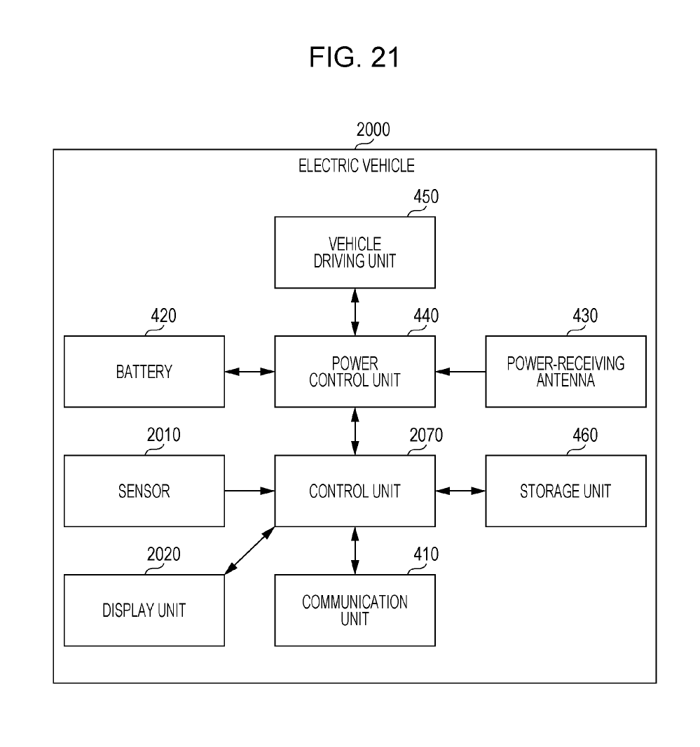

FIG. 21 is a functional block diagram of the electric vehicle 2000 according to the fourth embodiment.

As illustrated in FIG. 21, the electric vehicle 2000 includes a communication unit 410, a battery 420, a power-receiving antenna 430, a power control unit 440, a vehicle driving unit 450, a storage unit 460, a sensor 2010, a display unit 2020, and a control unit 2070.

In the electric vehicle 2000 illustrated in FIG. 21, functional units having substantially the same functions as those of the electric vehicle 400 described above in the first embodiment are denoted by the same reference numerals, and descriptions of those functional units are not given hereinafter.

The sensor 2010 reads the line marker applied to the roadway. The sensor 2010 sends, to the control unit 2070, information of the position of the read line marker relative to the electric vehicle 2000.

The display unit 2020 displays information specified by the control unit 2070. A display screen of the display unit 2020 may be implemented by a monitor of a vehicle navigation system, a liquid crystal display (LCD) provided in the vicinity of the speedometer of the electric vehicle 2000, or the front windshield of the electric vehicle 2000. Alternatively, for example, when a dedicated program for displaying guidance information generated by the control unit 470 through communication with an electric vehicle is installed on a portable terminal, the portable terminal may be used as a display screen.

In addition to the functions of the control unit 470 described in the first embodiment, the control unit 2070 determines an appropriate travel position of the electric vehicle 2000 on the basis of relative-position information sent from the sensor 2010. The control unit 2070 generates guidance information for navigation to the determined travel position and causes the guidance information to be displayed on the display unit 2020.

The control unit 2070 also obtains travel-speed information of the electric vehicle 2000 from the vehicle driving unit 450 and determines whether or not a speed indicated by the travel-speed information is an optimum speed for power supply. It is assumed that the optimum speed for power supply is a speed at which the power supply efficiency was determined to be high through advance simulation and is recorded in the storage unit 460. When the travel speed is lower than the optimum speed, the control unit 2070 generates guidance information for increasing the speed and causes the guidance information to be displayed on the display unit 2020. When the travel speed is higher than the optimum speed, the control unit 2070 generates guidance information for reducing the speed and causes the guidance information to be displayed on the display unit 2020.

### <Operation>

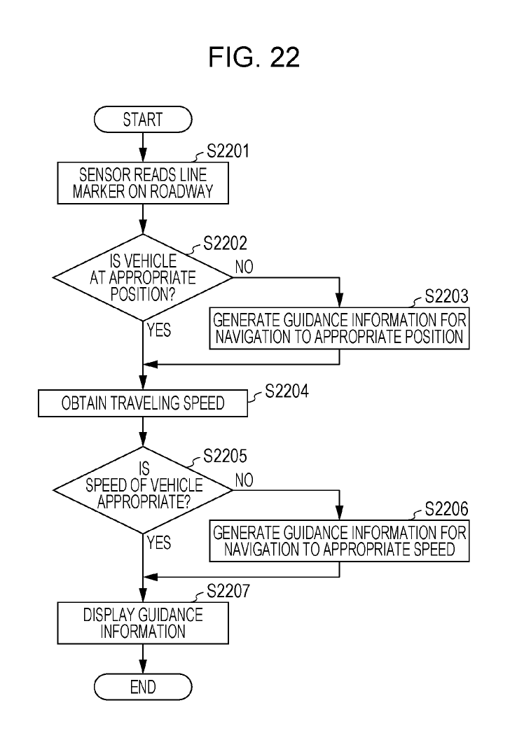

FIG. 22 is a flowchart illustrating operations of the electric vehicle 2000 according to the fourth embodiment. Operations that the electric vehicle 2000 performs to generate and display guidance information will be described with reference to FIG. 22.

When the electric vehicle 2000 receives a temporary ticket request from the power supply apparatus 200 and transmits a temporary ticket, the electric vehicle 2000 starts the sensor 2010. The sensor 2010 reads the line marker provided on the roadway (step S2201).

The sensor 2010 sends, to the control unit 2070, relative-position information obtained based on the position of the read line marker. Based on the relative-position information, the control unit 2070 determines whether or not the electric vehicle 2000 is traveling at an appropriate position (step S2202).

Upon determining that the electric vehicle 2000 is not traveling at an appropriate position (NO in step S2202) on the basis of the relative-position information, the control unit 2070 generates guidance information for giving an instruction for moving to the left, when the relative-position information indicates that the electric vehicle 2000 is traveling at the right side of the line marker, and generates guidance information for giving an instruction for moving to the right, when the relative-position information indicates that the electric vehicle 2000 is traveling at the left side of the line marker (step S2203). If the electric vehicle 2000 is traveling at an appropriate position (YES in step S2202), the process proceeds to step S2204.

Next, the control unit 2070 obtains the travel speed of the electric vehicle 2000 from the vehicle driving unit 450 (step S2204).

The control unit 2070 determines whether or not the obtained travel speed is an optimum travel speed (step S2205).

Upon determining that the obtained travel speed is not an appropriate travel speed (NO in step S2205), the control unit 2070 generates guidance information for navigation to an optimum speed (step S2206). Upon determining that the obtained travel speed is an appropriate travel speed (YES in step S2205), the process proceeds to step S2207.

The control unit 2070 causes the generated guidance information to be displayed on the display unit 2020 (step S2208) and ends the processing. If there is no guidance information to be displayed in step S2208, that is, if it is determined in step S2202 that the electric vehicle 2000 is traveling at an appropriate position and it is determined in step S2205 that the electric vehicle 2000 is traveling at an appropriate speed, the control unit 2070 ends the processing without displaying the guidance information.

The processing illustrated in FIG. 22 is executed sequentially (e.g., every 5 seconds) while power is supplied from the power supply apparatus 200.

### <First Modification of Fourth Embodiment>

Although the above description has been given of a case in which the electric vehicle 2000 locates the travel position thereof, the present disclosure is not limited thereto. The power supply system may create guidance information for navigation to an appropriate position by determining the position of the electric vehicle 2000 and sending the determined position to the electric vehicle 2000.

### <Configuration>

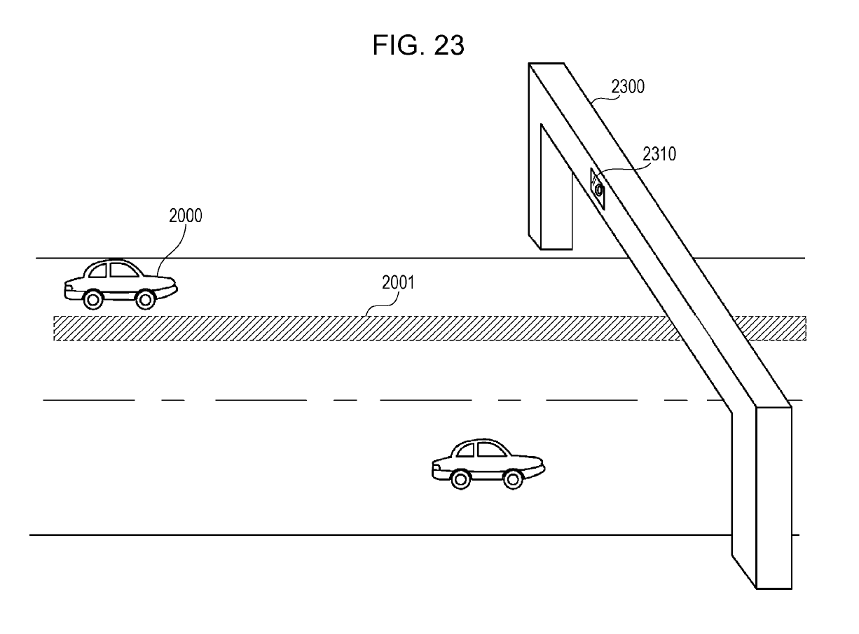

FIG. 23 is an external view illustrating an example of the external appearance of a power supply system according to a first modification. As illustrated in FIG. 23, the power supply system further includes navigators 2300. The navigators 2300 are apparatuses for appropriately navigating the traveling electric vehicle 2000 onto the power supply coil 2001. The navigators 2300 are installed for a roadway, in which the power supply coils 2001 are embedded, at predetermined intervals.

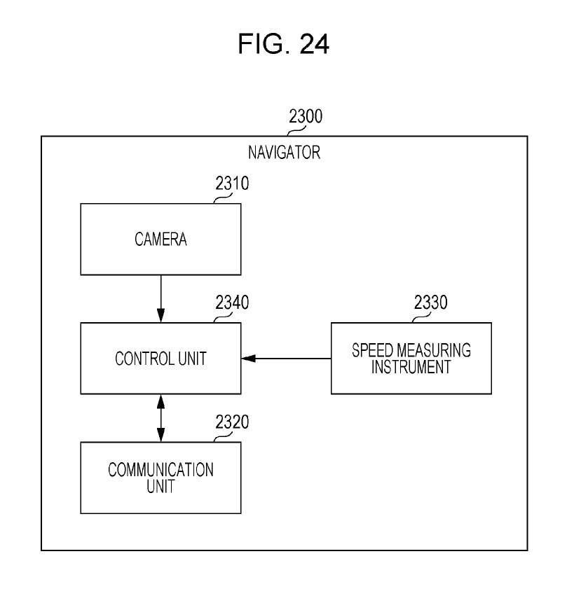

FIG. 24 is a functional block diagram of each navigator 2300.

As illustrated in FIG. 24, the navigator 2300 includes a camera 2310, a communication unit 2320, a speed measuring instrument 2330, and a control unit 2340.

As illustrated in FIG. 23, the camera 2310 is provided at a position where images of the roadway in which the power supply coil 2001 is embedded can be captured from an overhead viewpoint and where the power supply coil 2001 is photographed at the center of each of the captured images. The camera 2310 photographs the roadway and electric vehicles traveling on the roadway. The camera 2310 sends images acquired by the photography to the control unit 2340.

The communication unit 2320 communicates with the electric vehicle 2000 traveling in the vicinity thereof. The communication unit 2320 transmits a beacon signal, as appropriate, receives, from the electric vehicle 2000, a response signal corresponding to the beacon signal, and establishes a communication. The communication unit 2320 then transmits the guidance information, sent from the control unit 2340, to the electric vehicle 2000.

The speed measuring instrument 2330 has a function for measuring the travel speed of the electric vehicle 2000 by transmitting a certain electromagnetic wave to the traveling electric vehicle 2000 and receiving a reflection wave thereof. The speed measuring instrument 2330 also has a function for sending the measured speed to the control unit 2340.

On the basis of the image captured by the camera 2310 and the speed sent from the speed measuring instrument 2330, the control unit 2340 creates guidance information to be transmitted to the electric vehicle 2000 and causes the communication unit 2320 to transmit the guidance information. For creating the guidance information, the control unit 2340 extracts objects from each captured image sent from the camera 2310 and locates the position of an electric vehicle in the frame of the image. The control unit 2340 then determines whether or not the center of the electric vehicle in the captured image is a predetermined distance away from a center line (a perpendicular center line) of the frame. When the position of the electric vehicle lies at the right side of the center line by a predetermined amount or more, the control unit 2340 creates guidance information for moving to the left, and when the position of the electric vehicle lies at the left side of the center line by a predetermined amount or more, the control unit 2340 creates guidance information for moving to the right.

The control unit 2340 determines whether or not the speed sent from the speed measuring instrument 2330 is an optimum speed. The optimum speed is assumed to be pre-stored by the navigator 2300. When the speed sent from the speed measuring instrument 2330 is lower than the optimum speed, the control unit 2340 creates guidance information for increasing the speed, and when the speed sent from the speed measuring instrument 2330 is higher than the optimum speed, the control unit 2340 creates guidance information for reducing the speed.

The control unit 2340 instructs the communication unit 2320 so as to transmit, to the electric vehicle, guidance information including both the guidance information about the position and the guidance information about the speed.

The communication unit 410 in the electric vehicle 2000 sends the guidance information to the control unit 2070, and the control unit 2070 causes the sent guidance information to be displayed on the display unit 2020. This allows the user of the electric vehicle 2000 to perform driving at the appropriate position and at the appropriate speed on the basis of the guidance information displayed on the display unit 2020. Also, when the control unit 2070 has a function for automatically controlling the electric vehicle 2000, the electric vehicle 2000 can be automatically operated on the basis of the generated guidance information. The function for automatically controlling (automatically driving) the vehicle is to drive a vehicle by using a control mechanism, not by a manual operation of the user. In brief, for direction control, control is performed by rotating a motor, provided for a steering portion of a steering wheel, in a direction corresponding to an instruction for the left or right in the guidance information. Also, for speed control, rotation control for a drive motor for wheels is performed in accordance with an instruction for the speed in the guidance information.

### <Operation>

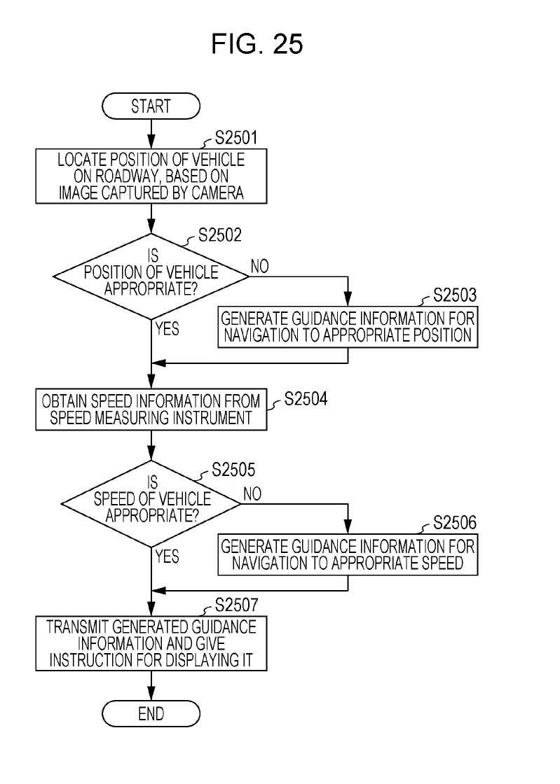

FIG. 25 is a flowchart illustrating operations of the navigator 2300 according to the first modification.

As illustrated in FIG. 25, first, the control unit 2340 in the navigator 2300 locates the travel position of the electric vehicle on a roadway, on the basis of the image sent from the camera 2310 (step S2501).

The control unit 2340 then determines whether or not the travel position of the electric vehicle is appropriate, on the basis of whether or not the electric vehicle in the image is away from the center by a predetermined distance or more (step S2502). If the control unit 2340 determines that the electric vehicle is traveling at an appropriate position (YES in step S2502), the process proceeds to step S2504.

Upon determining that the electric vehicle is not traveling at an appropriate position (NO in step S2502), the control unit 2340 creates guidance information for making the electric vehicle to travel at an appropriate position.

Next, the control unit 2340 obtains measured-speed information of the electric vehicle from the speed measuring instrument 2330 (step S2504).

The control unit 2340 then determines whether or not the obtained speed is an appropriate speed, on the basis of whether or not the speed differs from an optimum speed by a predetermined speed or more (step S2505).

Upon determining that the speed is an appropriate speed (YES in step S2505), the control unit 2340 advances to step S2507.

Upon determining that the speed is not an appropriate speed (NO in step S2505), the control unit 2340 generates guidance information for navigation to the appropriate speed.

The control unit 2340 transmits the generated guidance information about the position and the guidance information about the speed to the electric vehicle 2000 via the communication unit 410 (step S2507).

Upon receiving the guidance information, the electric vehicle 2000 displays the guidance information on the display unit 2020.

### <Second Modification of Fourth Embodiment>

A description will be further given of another scheme for locating the travel position of an electric vehicle.

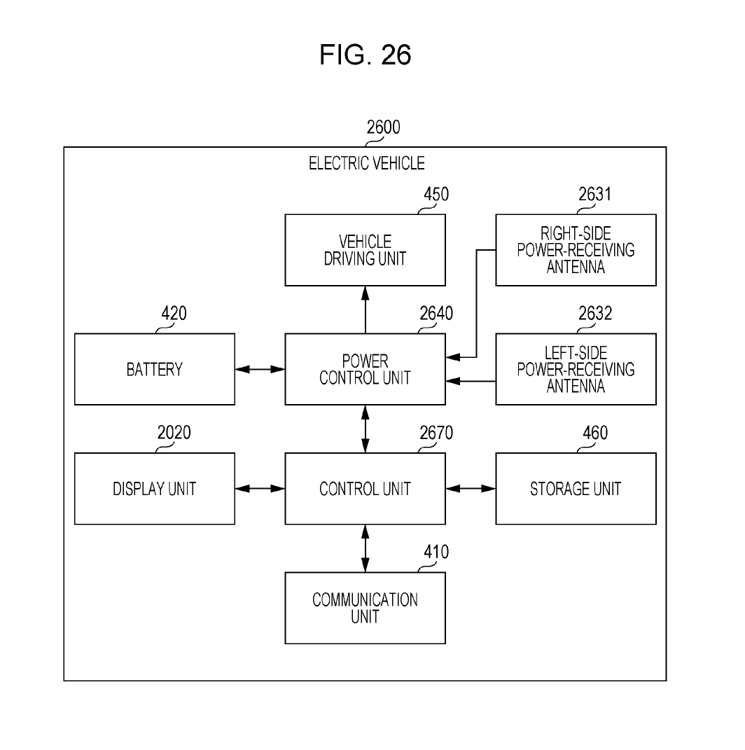

FIG. 26 is a functional block diagram of an electric vehicle 2600 according to a second modification.

The electric vehicle 2600 illustrated in FIG. 26 has two power-receiving antennas, unlike the electric vehicle 2000 described above. The power-receiving antennas are constituted by a right-side power-receiving antenna 2631 and a left-side power-receiving antenna 2632.

Although not illustrated, the right-side power-receiving antenna 2631 is provided to the right of the direction in which the electric vehicle 2600 travels, and the left-side power-receiving antenna 2632 is provided to the left of the direction in which the electric vehicle 2600 travels.

A power control unit 2640 then independently manages the amounts of power received by the power-receiving antennas 2631 and 2632 and sends the amounts of received power to the control unit 2070.

A control unit 2670 locates the travel position of the electric vehicle 2600, on the basis of the sent amounts of power received by the power-receiving antennas 2631 and 2632. That is, when the amount of power received by the right-side power-receiving antenna 2631 is larger than the amount of power received by the left-side power-receiving antenna 2632, this means that the electric vehicle 2600 is traveling at the left side of the power supply coil 2001. Conversely, when the amount of power received by the left-side power-receiving antenna 2632 is larger than the amount of power received by the right-side power-receiving antenna 2631, this means that the electric vehicle 2600 is traveling at the right side of the power supply coil 2001.

Accordingly, a control unit 2760 determines a difference of the amount of power received by the left-side power-receiving antenna 2632 from the obtained amount of power received by the right-side power-receiving antenna 2631. When the absolute value of the difference is smaller than or equal to a predetermined threshold, it is determined that the electric vehicle 2600 is traveling appropriately to some degree. When the absolute value of the difference is larger than the predetermined threshold and the difference has a positive value, the control unit 2670 creates guidance information for moving to the right, and when the difference has a negative value, the control unit 2670 creates guidance information for moving to the left.

In accordance with an estimated travel position, the control unit 2670 causes the guidance information for moving to the preferable travel position to be displayed on the display unit 2020.

### <Operation>

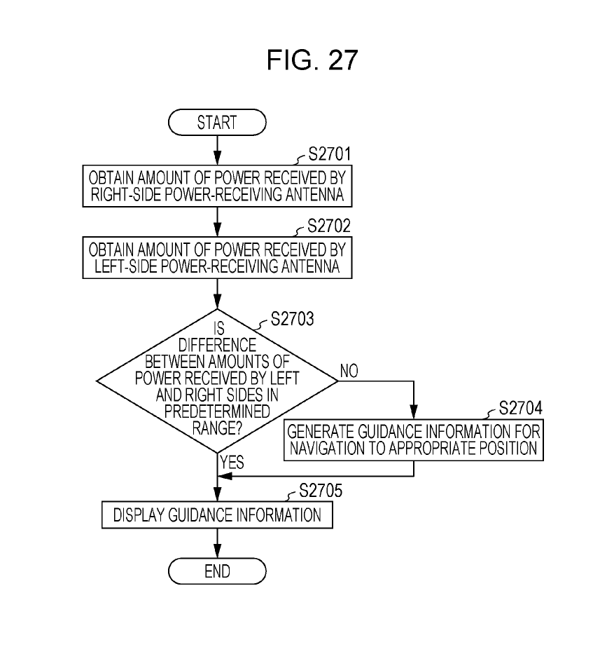

FIG. 27 is a flowchart illustrating operations that the electric vehicle 2600 performs to display the guidance information.

The control unit 2670 in the electric vehicle 2600 obtains, from the power control unit 2640, the amount of power received by the right-side power-receiving antenna 2631 (hereinafter referred to as the “amount of received right-side power”) (step S2701).

At the same time, the control unit 2670 obtains, from the power control unit 2640, the amount of power received by the left-side power-receiving antenna 2632 (hereinafter referred to as the “amount of received left-side power”) (step S2702).

The control unit 2670 determines a difference between the obtained amount of received right-side power and the obtained amount of received left-side power. The control unit 2670 then determines whether or not the absolute value of the difference is smaller than or equal to a predetermined threshold (step S2703).

If the absolute value of the difference is smaller than or equal to the predetermined threshold (step S2703), this means that the electric vehicle 2600 is traveling at an appropriate position to some degree, and thus ends the processing.

If the absolute value of the difference between the amount of received right-side power and the amount of received left-side power is larger than the predetermined threshold (NO in step S2703), the control unit 2670 determines whether a difference obtained by subtracting the amount of received left-side power from the amount of received right-side power has a positive value or a negative value. The control unit 2670 generates guidance information for moving to the left, if the difference has a positive value, and generates guidance information for moving to the right, if the difference has a negative value. The control unit then 2670 causes the guidance information to be displayed on the display unit 2020 and ends the processing.

The processing illustrated in FIG. 27 is repeatedly executed while the electric vehicle 2600 is traveling in a power supply lane.

The speed in the second modification is measured by the vehicle driving unit 450, as described in the above-described example, or is measured by the system, and guidance information for navigation to an optimum speed is created and displayed.

### <Display Example of Guidance Information>

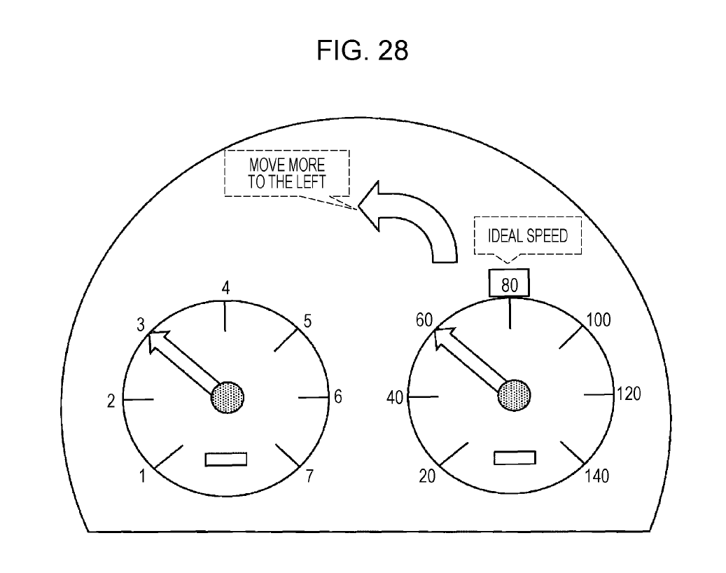

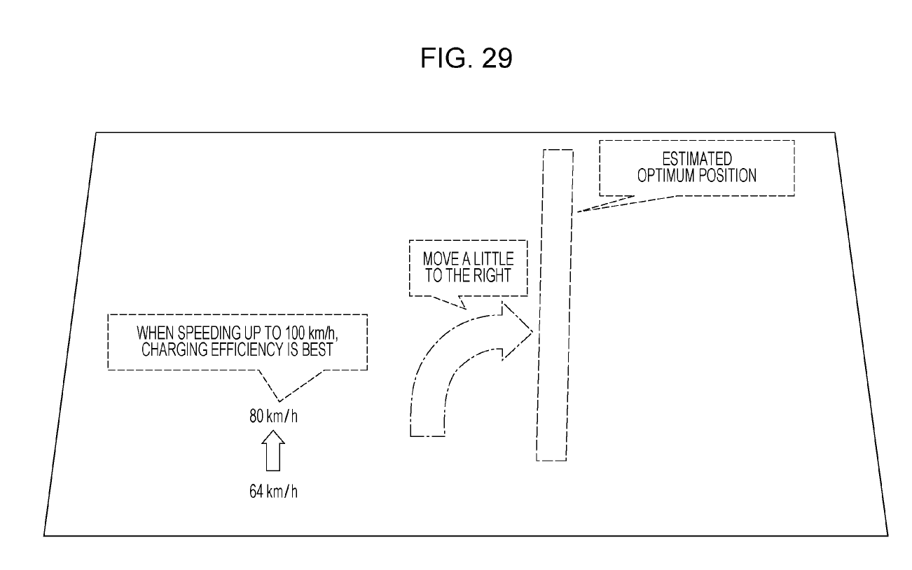

FIGS. 28 and 29 illustrate specific examples of display of the guidance information in the fourth embodiment.

FIG. 28 illustrates an example in which the guidance information is displayed on an LCD provided in the vicinity of the speedometer of the electric vehicle 2000.

As illustrated in FIG. 28, since the electric vehicle 2000 is traveling at the right side of the position where the power supply coil is installed, guidance information for instructing the driver to move to the left is displayed. At the same time, an ideal speed for power supply is also displayed.

FIG. 29 illustrates an example in which guidance information is displayed on the front windshield of the electric vehicle 2000.

As illustrated in FIG. 29, since the electric vehicle 2000 is traveling at the left side of the position where the power supply coil is installed, guidance information for instructing the driver to move to the right is displayed. At the same time, guidance information for instructing the driver to increase the speed to 80 km/h, which is an ideal speed for power supply, is displayed.

Thus, the electric vehicle 2000 detects whether or not it is traveling at an optimum travel position and at an optimum travel speed, and an optimum traveling method is presented based on the result of the detection, thereby making it possible to improve the power supply efficiency.

### Fifth Embodiment

The description in the fourth embodiment has been given of an example of an electric vehicle for giving guidance for a driving method for improving the charging efficiency in the power supply system in the above embodiments. In a fifth embodiment, a description will be given of one example of a navigation system for the owner of an electric vehicle to receive power supply with a high power-supply efficiency or high cost performance.

### <Configuration>

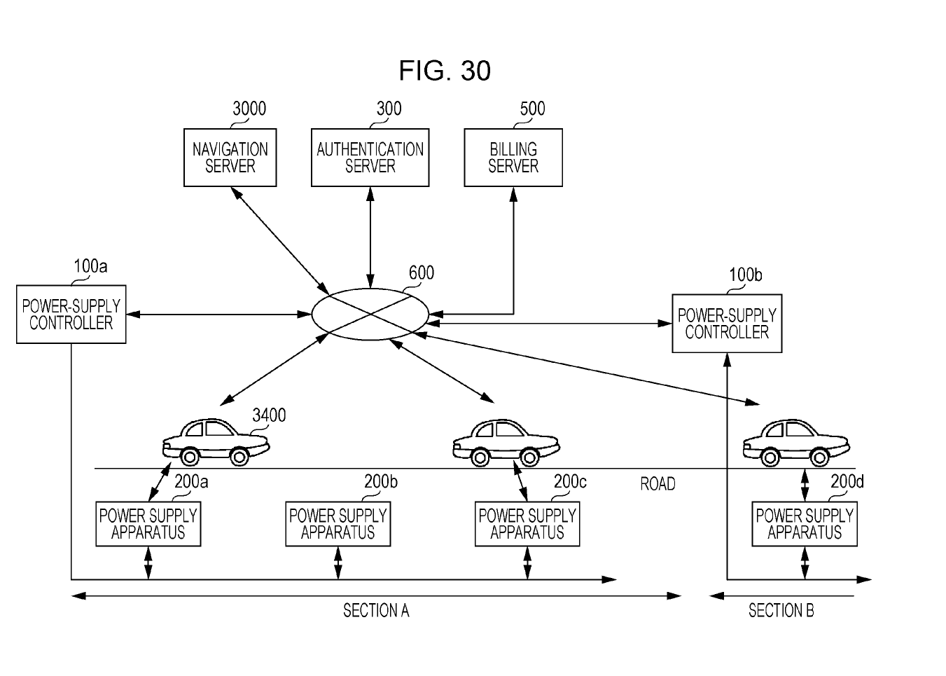

FIG. 30 is a diagram illustrating the configuration of a power supply system according to the fifth embodiment. The power supply system illustrated in FIG. 30 has a configuration in which a navigation server 3000 is further added to the power supply system illustrated in FIG. 1. Other elements are substantially the same as those in the first embodiment. Now, a description will be given of points that are different from the power supply system described in the first embodiment.

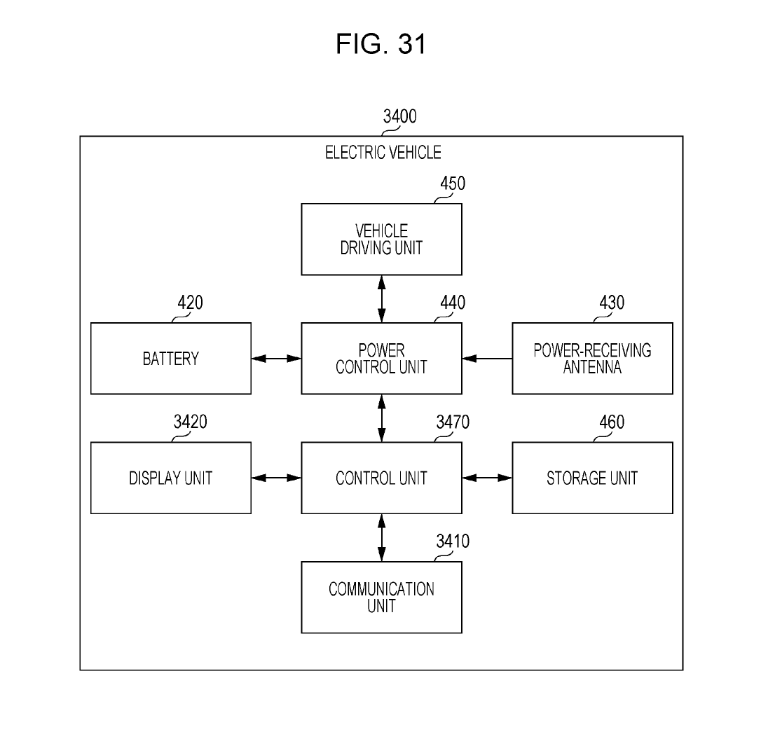

FIG. 31 is a functional block diagram of an electric vehicle 3400.

In addition to the functions of the communication unit 410 described above in the first embodiment, a communication unit 3410 in the electric vehicle 3400 communicates with the navigation server 3000 through the network 600.

A display unit 3420 displays information according to an instruction from a control unit 3470. The display unit 3420 displays route information about a route that connects from a current location to a destination via a power supply apparatus, the current location and the destination being specified by the control unit 3470.

A power control unit 3440 also detects the remaining battery level of the battery 420 and sends the remaining battery level to the control unit 3470.

When the control unit 3470 determines that the sent remaining battery level is not sufficient to arrive at the destination, the control unit 3470 issues a request for information about the power supply apparatus to the navigation server 3000. In accordance with the obtained information about the power supply apparatus, the control unit 3470 searches for a travel route that connects from the current location to the destination via the power supply apparatus and causes the route information to be displayed on the display unit 3420. A request signal for requesting the information about the power supply apparatus includes at least the current location information (latitude-and-longitude information) and destination information (latitude-and-longitude information) of the electric vehicle 3400.

The amount of power that is to be consumed when a route from the current location to the destination is traveled is calculated based on the distance from the current location to the destination and the amount of power to be consumed for the travel and is compared with the remaining battery level, to thereby determine whether or not the remaining battery level is sufficient to arrive at the destination. The distance of the route from the current location to the destination is obtained from a vehicle navigation system, and the amount of power consumed for traveling, which indicates the amount of power consumed per unit time, is pre-stored in the storage unit 460 or is obtained through calculation based on the amount of power consumed in a predetermined time during traveling. The search for the travel route is performed using a typical car-navigation system. The search for the travel route involves (I) searching for a route from the current location to a destination that is any of the obtained power supply apparatuses, (II) searching for a route from the power supply apparatus to an original destination, and (III) searching for a route from the single current location to the original destination via the power supply apparatus by combining the results of the two route searches.

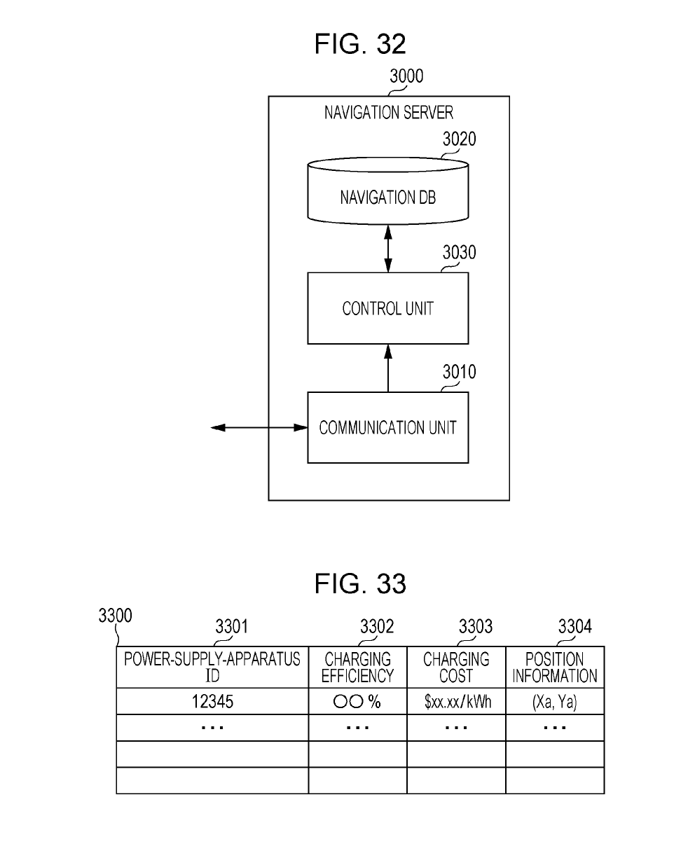

FIG. 32 is a functional block diagram of the navigation server 3000. As illustrated in FIG. 32, the navigation server 3000 includes a communication unit 3010, a navigation DB 3020, and a control unit 3030.

The communication unit 3010 has a function for executing communication with the electric vehicle 3400 through the network 600.

The navigation DB 3020 holds information about the places where power supply apparatuses are installed in the power supply system, the charging efficiencies of the power supply apparatuses, and so on.

The control unit 3030 controls the individual units in the navigation server 3000. When the control unit 3030 receives a request signal for requesting power-supply-apparatus information from the electric vehicle 3400 via the communication unit 3010, the control unit 3030 obtains the current location information and the destination information of the electric vehicle 3400 which are included in the request signal. The control unit 3030 then searches for a plurality of routes that connect from a location indicated by the current location information to a location indicated by the destination information. When there are power supply apparatuses on found routes, the control unit 3030 compiles the power-supply-apparatus information about the power supply apparatuses and causes the communication unit 3010 to transmit the power-supply-apparatus information to the electric vehicle 3400. The power-supply-apparatus information includes information about at least the position information, the charging efficiencies, and the charging costs of the power supply apparatuses on the found routes.

The configurations of the electric vehicle 3400 and the navigation server 3000 according to the fifth embodiment have been described thus far.

### <Data>

FIG. 33 is a conceptual data table illustrating the data structure of the navigation DB 3020.

As illustrated in FIG. 33, navigation information 3300 is information in which power-supply-apparatus IDs 3301, charging efficiencies 3302, charging costs 3303, and position information 3304 are associated with each other.

Each power-supply-apparatus ID 3301 is an identifier for identifying the corresponding power supply apparatus in the power supply system.

Each charging efficiency 3302 is a value indicating an average charging efficiency when the corresponding power supply apparatus is used. The charging efficiency 3302 is obtained by charging an electric vehicle by using the power supply coil of the power supply apparatus and determining an average value of values resulting from measuring the charging efficiency a plurality of times, and the average value is pre-stored.

Each charging cost 3303 is information that indicates an electricity cost when charging is performed using the corresponding power supply apparatus and that indicates a usage fee per unit time.

The position information 3304 indicates the position where the corresponding power supply apparatus is installed, and is indicated by latitude and longitude. The position information 3304 is used to specify the power supply apparatus along a route determined based on the current location information and the destination information of the electric vehicle 3400 which are included in a power-supply-apparatus request signal transmitted from the electric vehicle 3400.

### <Operation>

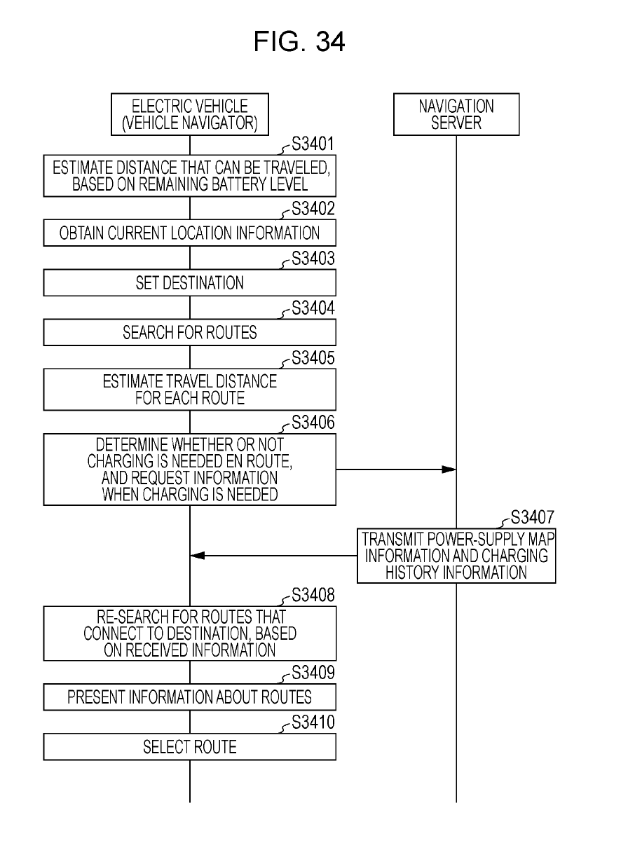

FIG. 34 is a sequence diagram illustrating processing for displaying route information up to a destination when the electric vehicle according to the fifth embodiment passes by the power supply apparatus.

As illustrated in FIG. 34, first, the control unit 3470 in the electric vehicle 3400 obtains the remaining battery level from the power control unit 3440 and estimates a distance that can be traveled (step S3401).

The control unit 3470 uses a global positioning system (GPS) to obtain the current location information (step S3402).

Next, the control unit 3470 obtains the destination information from the vehicle navigation system (step S3403).

The control unit 3470 searches for routes that connect to the destination on the basis of the obtained current location information and destination information (step S3404). The control unit 3470 estimates a travel distance for each found route (step S3405).

If the estimated travel distance is larger than the distance that can be traveled which was estimated in step S3401, the control unit 3470 transmits a request signal for requesting the power-supply-apparatus information to the navigation server 3000 (step S3406).

Upon receiving the request signal, the navigation server 3000 searches for travel routes on the basis of the current location information and the destination information, which are included in the received request signal, and transmits, to the electric vehicle 3400, information about power supply apparatuses that exist on found travel routes (step S3407).

Upon receiving the information about the power supply apparatuses, the electric vehicle 3400 re-searches for routes that connect from the current location to the destination via any (one or more) of the power supply apparatuses (step S3408).

The control unit 3470 causes information about found routes to be displayed on the display unit 3420. In this case, information about a charging cost when each route is used and information about the charging efficiency are also displayed (step S3409).

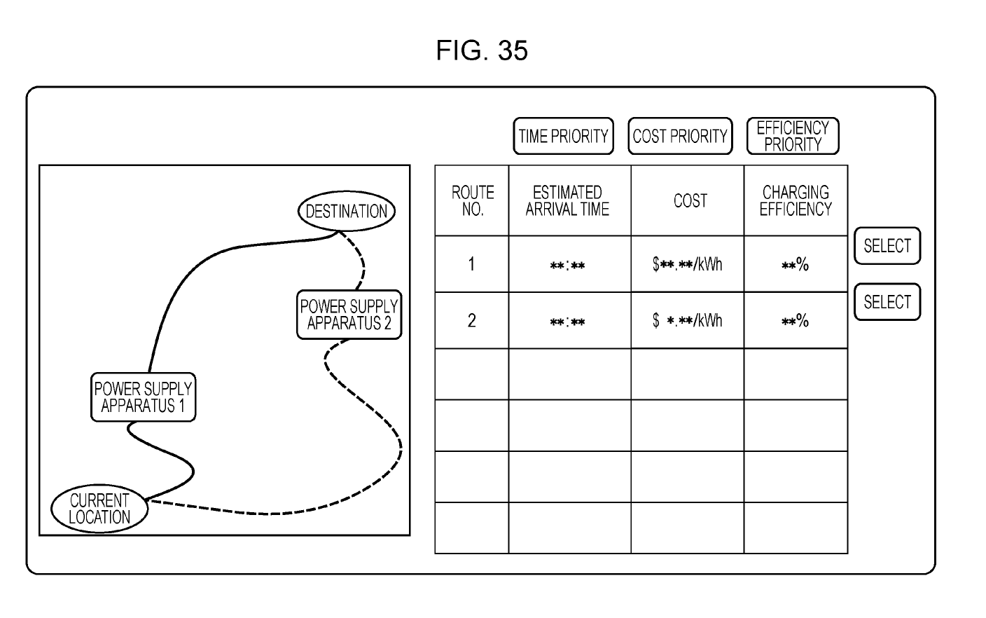

FIG. 35 illustrates one example of a route presentation screen. During presentation of routes, a graphical user interface (GUI) for receiving an input indicating what is to be given a priority in sorting a plurality of routes is also displayed, as illustrated in FIG. 35.

A user input for selecting one of the displayed routes is received, and a travel route is determined (step S3410).

### <Other Modifications>

Although the power control system according to the present disclosure has been described above in conjunction with the embodiments, the present disclosure is not limited thereto. Various modifications included as ideas of the present disclosure will be described below.

(1) The authentication scheme in the embodiments described above is one example, and any authentication scheme may be used.

For example, in the embodiments, a digital certificate is encrypted and sent, and the authentication server decodes the digital certificate with a cryptographic key corresponding thereto and verifies the legitimacy. For example, the authentication may be executed through input of a pre-defined password, rather than using a digital certificate. The authentication may also be executed using an existing authentication scheme, an authentication method to be developed in the future, or the like.

The procedure for the authentication in the above-described embodiments may be partly omitted in order to simplify the processing. For example, when the power-supply controller is trustworthy, the authentication steps (the processes in steps S1001 and S1002 in FIG. 10) in which the authentication server authenticates the power-supply controller may be omitted. In addition, for example, the processes (the processes in steps S1006 and S1007 in FIG. 10) in which the electric vehicle recognizes whether or not the power-supply controller is legitimate may be omitted.

(2) In the first and second embodiments, the electric vehicle 400 transmits the temporary ticket after receiving the temporary ticket request signal. However, since it is sufficient as long as the temporary ticket is delivered to the power supply apparatus, a configuration in which the electric vehicle 400 transmits the temporary ticket, as needed, may be used without the power supply apparatus transmitting the temporary ticket request signal.

(3) Although the authentication server 300 executes the authentication in the embodiments described above, the power-supply controller 100 may execute the authentication. That is, the power-supply controller 100 may have the electric-vehicle authentication function of the authentication server 300. In this case, for example, the processes for authenticating the power-supply controller in steps S1001 and S1002 in FIG. 10 can be omitted.

(4) In the first embodiment, the power-supply controller 100 may specify the power supply apparatus for executing power supply and may transmit the temporary ticket to the specified power supply apparatus, as in the case in which the power supply apparatus in the second embodiment specifies the power supply coil for executing power supply.

(5) Although the electric vehicle has the sensor for reading a line marker in the fourth embodiment described above, the arrangement may be such that the electric vehicle has a camera instead of the sensor, an image captured by the camera is analyzed, and a determination is made as to whether or not the electric vehicle is traveling at an appropriate position relative to the line marker.

In this case, the arrangement may be such that image analysis is performed on the captured image without using a line marker, and which position on a roadway the electric vehicle is traveling is analyzed to generate guidance information. This is based on the premise that the power supply coil is installed at the center of one lane on a roadway or the electric vehicle is notified of the installation position of the power supply coil relative to a roadway.

(6) In the fourth embodiment described above, both the guidance information about the position and the guidance information about the speed are created and are displayed. However, each time the guidance information about the position or the guidance information about the speed is generated, it may be displayed.

(7) In the fifth embodiment described above, the electric vehicle obtains the information about power supply apparatuses from the navigation server 3000. However, when the storage unit 460 has a storage capacity for storing information about all power supply apparatuses, the information about all power supply apparatuses may be stored in advance. This makes it possible to execute navigation processing, described in the fifth embodiment, without accessing the navigation server 3000.

(8) In the fifth embodiment described above, upon determining that the remaining battery level is not sufficient to travel to the destination, the electric vehicle 3400 executes the navigation processing for passing by the power supply apparatus. However, the navigation processing may be triggered by the remaining battery level being lower than or equal to a predetermined threshold or may be executed in accordance with an instruction from the user.

(9) Although the destination information is obtained from the vehicle navigation system in step S3403 in the fifth embodiment described above, the destination may be input by the user.

(10) The examples described in the above embodiments may also be combined together.

(11) The functional units in each apparatus in the power supply system in the embodiments described above may be realized as circuits for executing the functions of the functional units or may be realized by one or more processors executing a program. The power control system in the embodiment described above can be configured as a package of an integrated circuit (IC), a large scale integration (LSI), or another integrated circuit. The package is incorporated into various types of apparatus and is used to allow the various types of apparatus to realize various functions like those described in each embodiment.

Typically, the functional blocks may be realized in the form of a large scale integration (LSI), which is an integrated circuit. The functional blocks may be individually integrated into single chips or at least one or all of the functional blocks may be integrated into a single chip. Although the functional blocks are implemented in the form of an LSI in this case, they may also be called an integrated circuit (IC), a system LSI, a super LSI, or an ultra LSI depending on the difference in the degree of integration. The scheme for integrating the functional blocks into an integrated circuit is not limited to a scheme for LSI and may be realized with a dedicated circuit or a general-purpose processor. The functional blocks can also be implemented using a field programmable gate array (FPGA) that can be programmed after manufacture of an LSI and/or a reconfigurable processor that allows reconfiguration of connections and settings of circuit cells in an LSI.

(12) A control program having program code for causing a processor in each apparatus in the power supply system and various circuits connected to the processor to execute the operations for communication, the power supply processing (see FIG. 10 and FIGS. 13 to 16), the billing processing (see FIGS. 17 and 18), the operation guidance processing (see FIGS. 22, 25, and 27), the navigation processing (see FIG. 34), and so on described in the above embodiments can be recorded to a recording medium or can be distributed and disseminated via a various types of communication channel. Examples of such a recording medium include an IC card, a hard disk, an optical disk, a flexible disk, and a read-only memory (ROM). The distributed and disseminated control program is used through storage in a memory or the like that can be read by a processor, and the processor executes the control program to thereby realize the various functions described in the embodiments.

### <Appendices>

The description below will be given of examples of a power supply system, an electric vehicle, and a billing server according to the present embodiments and advantages thereof.

(a) A power supply system according to the present disclosure is directed to a power supply system that supplies power to an electric vehicle that travels on a roadway by using power supply apparatuses installed for the roadway. The power supply system includes: an authenticator that executes authentication as to whether or not the electric vehicle has legitimacy to receive power supply, before the electric vehicle arrives in a section where any of the power supply apparatuses is installed for the roadway; an issuer that issues a temporary ticket for the electric vehicle to receive power supplied from any of the power supply apparatuses, when the authenticator authenticates the electric vehicle; a first deliverer that delivers the temporary ticket to the electric vehicle; a second deliverer that delivers a temporary ticket, issued by the issuer, to each power supply apparatus. The power supply apparatus includes: a first receiver that receives a temporary ticket delivered by the second deliverer; a second receiver that receives a temporary ticket transmitted from electric vehicle; a determiner that determines whether or not the temporary ticket received by the first receiver and the temporary ticket received by the second receiver match each other; and a power supplier that supplies power to the electric vehicle, when the determiner determines that the temporary tickets match each other.

According to this configuration, the electric vehicle performs authentication with the authentication server, gives a request for issuing a temporary ticket for power supply, and transmits the issued temporary ticket to the power supply apparatus. The power supply apparatus verifies the received temporary ticket and supplies power to the electric vehicle. Accordingly, only an electric vehicle having the legitimacy to use the power supply system can use the power supply system, and the power supply can be started at an appropriate timing through transmission/reception of the temporary ticket. Thus, it is possible to prevent the power supply apparatus from wastefully discharging electricity and it is possible to prevent theft of electricity if electricity is discharged wastefully.

(b) In the power supply system according to (a) described above, the power supply apparatus may further include a first transmitter that transmits a request signal for requesting a temporary ticket, and the second receiver may receive the temporary ticket that the electric vehicle transmits in response to the request signal.

With this arrangement, the electric vehicle can transmit a temporary ticket in response to the temporary ticket request signal and can receive power supplied from the power supply apparatus at an appropriate timing.

(c) In the power supply system according to (a) described above, the power supply system may further include: a third receiver that receives identification information and authentication information of the electric vehicle from the electric vehicle, before the electric vehicle arrives in the section; an authentication requestor that requests the authenticator to authenticate the identification information and the authentication information; and a reporter that reports an authentication result of the authenticator to the issuer. The authenticator may execute authentication of the identification information and authentication information, the authentication being requested by the authentication requestor; and the issuer may issue the temporary ticket, based on an authentication result reported by the reporter.

With this arrangement, after checking the legitimacy of the electric vehicle, it is possible to supply power to the electric vehicle. Accordingly, it is possible to prevent power from being supplied to an illegitimate electric vehicle, and thus it is possible to prevent unwanted consumption of power.

(d) In the power supply system according to (a) described above, the second receiver further receives travel-speed information indicating a speed at which the electric vehicle travels and travel-route information indicating a route along which the electric vehicle travels; and the power supply system may further include: a specifier that specifies the power supply apparatus that executes power supply to the electric vehicle, based on the travel-speed information and the travel-route information; and a power supply instructor that causes the power supply apparatus, specified by the specifier, to execute power supply.

With this arrangement, the travel position of the electric vehicle can be located, and power can be supplied from an appropriate power supply apparatus.

(e) In the power supply system according to (a) described above, the specifier further determines a timing at which the electric vehicle passes by the power supply apparatus, based on the travel-speed information, and reports the determined timing to the power supply apparatus; and the power supplier executes starting and ending of the power supply, based on the reported timing.

With this arrangement, since the power supply apparatus can supply power by predicting the timing at which the electric vehicle passes, power can be more appropriately supplied, and power loss can be suppressed.

(f) The power supply system according to (a) described above may further include a biller that executes billing on the electric vehicle, when the power supplier executes power supply to the electric vehicle.

With this arrangement, the owner of the electric vehicle that uses the power supply system can be billed for the usage fee.

(g) In the power supply system according to (f) described above, the biller may execute the billing in accordance with the amount of power that the power supplier supplies to the electric vehicle.

With this arrangement, when the amount of power supplied by the power supply side is trustworthy, it is possible to execute billing based on the amount of supplied power.

(h) In the power supply system according to (f) or (g) described above, the biller can execute the billing in accordance with the amount of power received by the electric vehicle.

With this arrangement, when the amount of power received by the power-receiving side is trustworthy, it is possible to execute billing based on the amount of received power.

(i) A power supply apparatus according to the present disclosure is directed to a power supply apparatus that supplies power to an electric vehicle that travels on a roadway. The power supply apparatus includes: a first receiver that receives a first temporary ticket delivered from a server: a second receiver that receives a second temporary ticket transmitted from the electric vehicle; a determiner that determines whether or not the first temporary ticket received by the first receiver and the second temporary ticket received by the second receiver match each other; and a power supplier that supplies power to the electric vehicle, when the determiner determines that the first temporary ticket and the second temporary ticket match each other.

With this arrangement, the power supply apparatus executes power supply after receiving the temporary ticket from the electric vehicle and verifying the match. Thus, the power supply apparatus can appropriately supply power to the electric vehicle, and can suppress power loss caused by electricity theft due to impersonation of an electric vehicle, unwanted power supply performed when no electric vehicle is traveling, or the like.

(j) A management server according to the present disclosure is directed to a management server that manages power supply performed on an electric vehicle that travels on a roadway, by controlling power supply apparatuses installed for the roadway. The management server includes: an authenticator that performs authentication as to whether or not the electric vehicle has legitimacy to receive power supply, before the electric vehicle arrives in a section where any of the power supply apparatuses is installed for the roadway; an issuer that issues a temporary ticket for the electric vehicle to receive power supplied from any of the power supply apparatuses, when the authenticator authenticates the electric vehicle; a first deliverer that delivers the temporary ticket to the electric vehicle; and a second deliverer that delivers a temporary ticket, issued by the issuer, to each power supply apparatus.

With this arrangement, the management server can issue a temporary ticket to a legitimate electric vehicle. Since the management server also transmits the temporary ticket, issued to the electric vehicle, to the power supply apparatuses, each power supply apparatus can determine whether or not power supply may be performed on the electric vehicle, by using the temporary ticket received from the management server. As a result, it is possible to suppress power loss caused by electricity theft due to impersonation of an electric vehicle, unwanted power supply performed when no electric vehicle is traveling, or the like.

(k) An electric vehicle according to the present disclosure is directed to an electric vehicle that performs, while traveling, charging using power supply apparatuses installed for a roadway. The electric vehicle includes: a battery unit that has one or more batteries; an authenticator that communicates and connects to a management server to transmit an authentication request for the electric vehicle, before the electric vehicle arrives in a section where any of the power supply apparatuses is installed for the roadway; a receiver that receives a temporary ticket that the management server transmits in response to successful authentication of the electric vehicle, the authentication being performed by the management server; a transmitter that transmits the received temporary ticket to each power supply apparatus; a power receiver that receives power from any of the power supply apparatuses; and a charging controller that charges the battery unit by using the power received by the power receiver.

With this arrangement, even when traveling, the electric vehicle can receive power supplied from the power supply apparatus, as appropriate.

(l) An electric vehicle according to the present disclosure is directed to an electric vehicle that performs, while traveling, charging by using a power supply apparatus installed for a roadway. The electric vehicle includes: a power receiver that receives power from the power supply apparatus; and a presenter that presents, when the power reception is not efficient, a traveling method by which a power-receiving efficiency of the power receiver increases.

With this arrangement, it is possible to present the driver of the electric vehicle with a driving method by which the power-supply efficiency increases.

(m) In the electric vehicle according to (l) described above, the electric vehicle may further include a sensor that reads a line marker provided on a roadway; and the presenter may present the driving method, based on a positional relationship between the line marker read by the sensor and the electric vehicle.

With this arrangement, it is possible to present the driver of the electric vehicle with a driving method by which the power-supply efficiency increases.

(n) In the electric vehicle according to (l) described above, the electric vehicle may include a receiver that receives information about an efficient traveling method, based on a travel position of the electric vehicle which is obtained by the power supply system capturing an image of a lane in which the electric vehicle is traveling; and the presenter may present the traveling method received by the receiver.

With this arrangement, it is possible to present the driver of the electric vehicle with a driving method by which the power-supply efficiency increases.

(o) In the electric vehicle according to (l) described above, the power receiver may include: a right-side power receiver installed to the right of the direction in which the electric vehicle travels; and a left-side power receiver that is installed to the left of the direction in which the electric vehicle travels. The presenter may present the traveling method, based on the amount of power received by the right-side power receiver and the amount of power received by the left-side power receiver.

With this arrangement, it is possible to present the driver of the electric vehicle with a driving method by which the power-supply efficiency increases.

(p) The electric vehicle according to (l) described above may further include a determiner that determines whether or not the power reception is efficient; and a requestor that requests the power supply apparatus so as to stop the power supply, when it is determined that the power reception is not efficient.

With this arrangement, when the power supply efficiency is low, it is possible to issue a request for stopping the power supply. Thus, from the viewpoint of the owner of the electric vehicle, it is possible to prevent an unreasonable electricity fee from being requested for inefficient charging, and from the viewpoint of the power supply system, it is possible to suppress power loss.

(q) An electric vehicle according to the present disclosure is directed to an electric vehicle that uses a power supply system that supplies power to an electric vehicle that travel on a roadway, by using power supply apparatuses installed for the roadway. The electric vehicle includes: a requestor that issues a request for information about the power supply apparatuses to the power supply system; a destination obtainer that obtains a destination of the electric vehicle; a current location obtainer that obtains a current location of the electric vehicle; and a presenter that presents routes from the current location to the destination which allow use of any of the power supply apparatuses, based on the information about the power supply apparatuses.

The electric vehicle allows the driver to recognize routes from the current location to the destination via any of the power supply apparatuses.

(r) The electric vehicle according to (q) described above may further include a remaining-battery-level obtainer that obtains a remaining battery level of a held battery; and the requestor may issue a request for the information about the power supply apparatuses when it is determined that the remaining battery level is not sufficient to arrive at the destination.

This makes it possible to prevent an event in which the electric vehicle cannot arrive at the destination because of insufficient power.

(s) In the electric vehicle according to (q) or (r) described above, the presenter may further present a charging efficiency in association with each route.

This makes it possible to select an optimum route for the user by referring to the power-receiving efficiency.

(t) In the electric vehicle according to (q) to (s) described above, the presenter may present a charging fee in association with each route.

This makes it possible to select an optimum route for the user by referring to a fee for the received power.

(u) A billing server according to the present disclosure is directed to a billing server that executes, in a power supply system that supplies power to an electric vehicle that travels on a roadway by using a power supply apparatus installed for a roadway, billing on an owner of the electric vehicle. The billing server includes: a selector that selects one of a billing method based on an amount of power that the power supply apparatus supplies to the electric vehicle, a billing method based on an amount of power received by the electric vehicle, and a billing method based on both the amount of supplied power and the amount of received power; and a biller that executes billing in accordance with the billing method selected by the selector.

With this arrangement, the owner of an electric vehicle that receives power by using the power supply system can be billed for a usage fee for the charging.

The power supply system according to the present disclosure can be utilized as a system that allows a traveling electric vehicle to be charged.

What is claimed is:

1. A power supply method for a power supply system, the method comprising:
causing an authentication server to execute authentication as to whether or not an electric vehicle has legitimacy to receive power supply, before the electric vehicle arrives in a section where a power supply apparatus is installed for a roadway; and
delivering a first temporary ticket to the electric vehicle and delivering a second temporary ticket to the power supply apparatus when the authentication server authenticates that the electric vehicle has the legitimacy, wherein
the power supply apparatus
receives the delivered second temporary ticket,
receives the first temporary ticket when the first temporary ticket is transmitted from the electric vehicle,
determines whether or not the received second temporary ticket and the received first temporary ticket match each other, and
supplies power to the electric vehicle, upon determining that the received second temporary ticket and the received first temporary ticket match each other.

2. The power supply method according to claim 1, wherein
when the authentication server authenticates that the electric vehicle has the legitimacy, the power supply system issues the first temporary ticket and the second temporary ticket, the first temporary ticket is delivered to the electric vehicle, and the second temporary ticket is delivered to the power supply apparatus.

3. The power supply method according to claim 1, wherein
the power supply apparatus
transmits a request signal for requesting the first temporary ticket to the electric vehicle, and
receives the first temporary ticket that the electric vehicle transmits in response to the request signal.

4. The power supply method according to claim 1, wherein
the power supply system
receives identification information and authentication information of the electric vehicle from the electric vehicle, before the electric vehicle arrives in the section,
requests the authentication server to authenticate the identification information and the authentication information, and
issues the first temporary ticket and the second temporary ticket, based on an authentication result reported from the authentication server.

5. The power supply method according to claim 1, wherein
the power supply apparatus further receives, from the electric vehicle, travel-speed information indicating a speed at which the electric vehicle travels and travel-route information indicating a route along which the electric vehicle travels;
the power supply system further specifies the power supply apparatus that executes power supply to the electric vehicle, based on the travel-speed information and the travel-route information; and
the specified power supply apparatus supplies power to the electric vehicle.

6. The power supply method according to claim 5, wherein
the power supply system further determines a timing at which the electric vehicle passes by the power supply apparatus, based on the travel-speed information, and reports the determined timing to the power supply apparatus; and
the power supply apparatus executes starting and ending of the power supply, based on the reported timing.

7. The power supply method according to claim 1, wherein
the power supply system further comprises a billing server that executes billing processing in association with a user ID indicating a user of the electric vehicle, when the power supply apparatus executes the power supply to the electric vehicle.

8. The power supply method according to claim 7, wherein
the billing server executes the billing processing in accordance with an amount of power that the power supply apparatus supplies to the electric vehicle.

9. The power supply method according to claim 7, wherein
the billing server executes the billing processing in accordance with an amount of power received by the electric vehicle.

10. The power supply method according to claim 1, wherein
in the authentication, a user ID that is identification information indicating an electric vehicle or an owner thereof is used, and when it is determined that the user ID matches pre-stored information, it is determined that the electric vehicle has the legitimacy to receive power supply.

11. A power supply system comprising:
an authentication server; and
a power-supply controller that
causes the authentication server to execute authentication as to whether or not an electric vehicle has legitimacy to receive power supply, before the electric vehicle arrives in a section where a power supply apparatus is installed for a roadway, and
delivers a first temporary ticket to the electric vehicle and delivers a second temporary ticket to the power supply apparatus when the authentication server authenticates that the electric vehicle has the legitimacy, wherein
the power supply apparatus
receives the delivered second temporary ticket,
receives the first temporary ticket when the first temporary ticket is transmitted from the electric vehicle,
determines whether or not the received second temporary ticket and the received first temporary ticket match each other, and
supplies power to the electric vehicle, upon determining that the received second temporary ticket and the received first temporary ticket match each other.

12. A power supply apparatus used in the power supply system according to claim 11.

13. An electric vehicle that receives power supplied from the power supply apparatus used in the power supply system according to claim 11.

14. A billing server used in the power supply system according to claim 11, the billing server comprising:
a selector that receives amount-of-supplied-power information indicating an amount of power supplied from the power supply apparatus to the electric vehicle and performs billing processing for the amount of supplied power in association with a user ID indicating a user of the electric vehicle.

15. A billing server used in the power supply system according to claim 11, the billing server comprising:
a selector that selects one of a first billing method based on an amount of power that the power supply apparatus supplies to the electric vehicle, a second billing method based on an amount of power received by the electric vehicle, and a third billing method based on both the amount of power supplied and the amount of power received; and
a billing processor that executes the billing processing in accordance with the billing method selected by the selector.

16. A billing processing method executed by a billing server used in the power supply system according to claim 11, the billing processing method comprising:
selecting one of a first billing method based on an amount of power that the power supply apparatus supplies to the electric vehicle, a second billing method based on an amount of power received by the electric vehicle, and a third billing method based on both the amount of power supplied and the amount of power received; and
executing the billing processing in accordance with the selected billing method.

17. A power-supply controller used in a power supply system, the power-supply controller comprising:
causing an authentication server to execute authentication as to whether or not an electric vehicle has legitimacy to receive power supply, before the electric vehicle arrives in a section where a power supply apparatus is installed for a roadway; and
delivering a first temporary ticket to the electric vehicle and delivering a second temporary ticket to the power supply apparatus when the authentication server authenticates that the electric vehicle has the legitimacy, wherein
the power supply apparatus
receives the delivered second temporary ticket,
receives the first temporary ticket when the first temporary ticket is transmitted from the electric vehicle,
determines whether or not the received second temporary ticket and the received first temporary ticket match each other, and
supplies power to the electric vehicle, upon determining that the received second temporary ticket and the received first temporary ticket match each other.

18. A power supply apparatus that supplies power to an electric vehicle that travels on a roadway, the power supply apparatus comprising:
a first receiver that receives a first temporary ticket delivered from a server:
a second receiver that receives a second temporary ticket transmitted from the electric vehicle;
a determiner that determines whether or not the first temporary ticket received by the first receiver and the second temporary ticket received by the second receiver match each other; and
a power supplier that supplies power to the electric vehicle, when the determiner determines that the first temporary ticket and the second temporary ticket match each other.

19. A management server that controls a power supply apparatus installed for a roadway and manages power supply performed on an electric vehicle that travels on the roadway, the management server comprising:
a communicator that is connected to an authentication server that performs authentication as to whether or not the electric vehicle has legitimacy to receive power supply, before the electric vehicle arrives in a section where the power supply apparatus is installed for the roadway;
a first deliverer that delivers a first temporary ticket to the electric vehicle as a temporary ticket for the electric vehicle to receive power supplied from the power supply apparatus, upon receiving, from the authentication server via the communicator, an authentication result indicating that the electric vehicle has the legitimacy; and
a second deliverer that delivers a second temporary ticket to the power supply apparatus.

20. A power-supply control method that controls a power supply apparatus installed for a roadway, the method comprising:
performing, by using an authentication server, authentication as to whether or not an electric vehicle that travels on the roadway has legitimacy to receive power supply, before the electric vehicle arrives in a section where the power supply apparatus is installed for the roadway;
delivering a first temporary ticket to the electric vehicle as a temporary ticket for the electric vehicle to receive power supplied from the power supply apparatus, when the authentication server authenticates that the electric vehicle has the legitimacy; and
delivering a second temporary ticket to the power supply apparatus.

21. An electric vehicle that is charged while traveling by using a power supply apparatus installed for a roadway, the electric vehicle comprising:
a battery unit that has one or more batteries;
a power receiver that receives power from the power supply apparatus;
a communicator connected to an authentication server that performs authentication as to whether or not the electric vehicle has legitimacy to receive power supply and a management server that delivers a temporary ticket for the electric vehicle to receive power supplied from the power supply apparatus; and
a power controller that performs power control on the electric vehicle, wherein
the power controller
transmits an authentication request for the electric vehicle by using the communicator to connect to the authentication server, before the electric vehicle arrives in a section where the power supply apparatus is installed for the roadway,
transmits a delivery request for the temporary ticket to the management server, in response to successful authentication of the electric vehicle, the authentication being performed by the authentication server, wherein
in response to the delivery request, the management server delivers a first temporary ticket to be delivered to the electric vehicle and a second temporary ticket to be delivered to the power supply apparatus,
receives the first temporary ticket from the management server,
transmits the received first temporary ticket to the power supply apparatus, and
charges the battery unit by using power received from the power supply apparatus via the power receiver, when the power supply apparatus determines that the first temporary ticket and the second temporary ticket that the power supply apparatus receives from the management server match each other.
